(19) United States
(12) Patent Application Publication
(10) Pub. No.: US 2026/0127033 A1
(43) Pub. Date: May 7, 2026

(54) Artificial Intelligence Agent Systems for User-Specific Tasks

(71) Applicant: DeepMind Technologies Limited, London (GB)

(72) Inventors: Pengfei Xing, San Jose, CA (US); Andrew Gallagher, Fremont, CA (US); Ting Liu, Playa Vista, CA (US); Robert McDonald, Boca Raton, FL (US)

(21) Appl. No.: 18/940,067

(22) Filed: Nov. 7, 2024

(51) Int. Cl. G06F 9/50

(52) U.S. Cl. CPC G06F 9/5027

(57) ABSTRACT

The present disclosure is directed to artificial intelligence agent systems for user-specific tasks. The systems and methods disclosed herein can obtain a query descriptive of a task to be performed by an agent system; generate a routing prompt based on the query; provide the routing prompt as input to a routing mechanism of the agent system; determine to access a user-specific memory layer of the agent system based on an output of the routing mechanism of the agent system in response to the routing prompt; generate a retrieval prompt based on the query; and generate an output of the agent system using the user-specific memory layer and based on the retrieval prompt.

### FIELD

The present disclosure relates generally to artificial intelligence systems. More particularly, the present disclosure relates to artificial intelligence (“AI”) agent systems for user-specific tasks.

### BACKGROUND

An artificial intelligence agent (“agent”) can include a set of computer-executable instructions and/or other computer-readable information that is collectively configured to process inputs to generate outputs. For example, an agent can receive data, apply computational processes to analyze the data according to programmed algorithms or models, and produce results that are determined by the parameters and/or structure of the underlying algorithms or models.

### SUMMARY

Aspects and advantages of embodiments of the present disclosure will be set forth in part in the following description, or can be learned from the description, or can be learned through practice of the embodiments.

Example aspects of the present disclosure provide a computer-implemented method. In some implementations, the computer-implemented method can include obtaining, by a computing system including one or more computing devices, a query descriptive of a task to be performed by an agent system. In some implementations, the computer-implemented method can include generating, by the computing system, a routing prompt based on the query. In some implementations, the computer-implemented method can include providing, by the computing system, the routing prompt as input to a routing mechanism of the agent system. In some implementations, the computer-implemented method can include determining, by the computing system, to access a user-specific memory layer of the agent system based on an output of the routing mechanism in response to the routing prompt. In some implementations, the computer-implemented method can include generating, by the computing system, a retrieval prompt based on the query. In some implementations, the computer-implemented method can include generating, by the computing system, an output of the agent system using the user-specific memory layer and based on the retrieval prompt.

In some implementations, obtaining the query includes obtaining first data from a calling device, the first data including the query in a first modality. In some implementations, obtaining the query further includes extracting second data from the first data, the second data including the query in a second modality. In some implementations, obtaining the query further includes generating the routing prompt based on the second data including the query in the second modality.

In some implementations, the first modality includes image data depicting textual characters including the query and the second modality includes text data representative of the textual characters including the query.

In some implementations, obtaining the query further includes obtaining an instruction to access a camera of the calling device. In some implementations, obtaining the query further includes, in response to the instruction, obtaining video data captured by the calling device. In some implementations, obtaining the query further includes determining to employ an image data extraction tool to extract the image data from the video data captured by the calling device. In some implementations, obtaining the query further includes, based on an output of the image data extraction tool, extracting the image data from the video data captured by the calling device. In some implementations, obtaining the query further includes generating the query descriptive of the task to be performed by the agent system based on the image data extracted from the video data captured by the calling device.

In some implementations, the routing prompt includes metadata associated with the query.

In some implementations, generating the output of the agent system includes retrieving one or more retrieved data items from the user-specific memory layer based on a comparison between indices of one or more data items contained in the user-specific memory layer and the retrieval prompt. In some implementations, generating the output of the agent system further includes generating the output of the agent system based on the one or more retrieved data items.

In some implementations, generating the output of the agent system based on the one or more retrieved data items includes prompting the agent system to select one or more output items from the one or more retrieved data items, the output of the agent system including the one or more output items.

In some implementations, the indices of the one or more data items contained in the user-specific memory layer include respective embeddings of the one or more data items.

In some implementations, retrieving the one or more retrieved data items from the user-specific memory layer based on a comparison between the indices of the one or more data items and the retrieval prompt includes generating a retrieval embedding based on the retrieval prompt. In some implementations, retrieving the one or more retrieved data items further includes selecting the one or more retrieved data items based on a distance between the retrieval embedding and the respective embeddings of the one or more data items.

In some implementations, determining to access a user-specific memory layer of the agent system includes determining that the agent system will evaluate at least one user-specific characteristic in performing the task, the user-specific characteristic uniquely associated with a user.

In some implementations, the user-specific memory layer includes one of a local storage of a calling device or a cloud storage directory associated with a user.

In some implementations, the routing mechanism includes a routing tool of the agent system, and the routing tool is generated by the agent system to classify a query as one of a user-specific query or a user-agnostic query.

In some implementations, the method further includes obtaining, by the computing system, a second query descriptive of a second task to be performed by the agent system. In some implementations, the method further includes generating, by the computing system, a second routing prompt based on the second query. In some implementations, the method further includes providing, by the computing system, the second routing prompt to the routing mechanism of the agent system. In some implementations, the method further includes determining, by the computing system, to access a public data interface to perform the second task using the agent system based on an output of the routing mechanism of the agent system in response to the second routing prompt. In some implementations, the method further includes generating, by the computing system, a second retrieval prompt based on the second query. In some implementations, the method further includes generating, by the computing system, a second output of the agent system by accessing the public data interface based on the second retrieval prompt.

In some implementations, the retrieval prompt and the second retrieval prompt include different instruction formats.

In some implementations, the method further includes obtaining, by the computing system, a third query descriptive of a third task to be performed by the agent system. In some implementations, the method further includes generating, by the computing system, a third routing prompt based on the third query. In some implementations, the method further includes providing, by the computing system, the third routing prompt to the routing mechanism of the agent system. In some implementations, the method further includes determining, by the computing system, to provide the query to the agent system based on an output of the routing mechanism of the agent system in response to the third routing prompt. In some implementations, the method further includes generating, by the computing system, a third output of the agent system based on the third query.

Example aspects of the present disclosure provide a computing system. The computing system can include one or more processors and one or more non-transitory, computer-readable media storing instructions that, when implemented, cause the one or more processors to perform operations. In some implementations, the operations include obtaining a query descriptive of a task to be performed by an agent system. In some implementations, the operations include generating a routing prompt based on the query. In some implementations, the operations include providing the routing prompt as input to a routing mechanism of the agent system. In some implementations, the operations include determining to access a user-specific memory layer of the agent system based on an output of the routing mechanism of the agent system in response to the routing prompt. In some implementations, the operations include generating a retrieval prompt based on the query. In some implementations, the operations include generating an output of the agent system using the user-specific memory layer and based on the retrieval prompt.

In some implementations, obtaining the query includes obtaining first data from a calling device, the first data including the query in a first modality. In some implementations, obtaining the query includes extracting second data from the first data, the second data including the query in a second modality. In some implementations, obtaining the query includes generating the routing prompt based on the second data including the query in the second modality.

In some implementations, the routing prompt includes metadata associated with the query.

In some implementations, generating the output of the agent system includes retrieving one or more retrieved data items from the user-specific memory layer based on a comparison between indices of one or more data items contained in the user-specific memory layer and the retrieval prompt and generating the output of the agent system based on the one or more retrieved data items.

In some implementations, the indices of the one or more data items contained in the user-specific memory layer are based on respective embeddings of the one or more data items.

In some implementations, retrieving the one or more retrieved data items from the user-specific memory layer based on a comparison between the indices of the one or more data items and the retrieval prompt includes generating a retrieval embedding based on the retrieval prompt. In some implementations, retrieving the one or more retrieved data items includes selecting the one or more retrieved data items based on a distance between the retrieval embedding and the respective embeddings of the one or more data items.

Example aspects of the present disclosure provide one or more non-transitory, computer-readable media storing instructions that, when implemented, cause one or more processors to perform operations. In some implementations, the operations include obtaining a query descriptive of a task to be performed by an agent system. In some implementations, the operations include generating a routing prompt based on the query. In some implementations, the operations include providing the routing prompt as input to a routing mechanism of the agent system. In some implementations, the operations include determining to access a user-specific memory layer of the agent system based on an output of the routing mechanism of the agent system in response to the routing prompt. In some implementations, the operations include generating a retrieval prompt based on the query. In some implementations, the operations include generating an output of the agent system using the user-specific memory layer and based on the retrieval prompt.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIGS. 1-4 illustrate block diagrams of example systems according to example implementations of aspects of the present disclosure;

FIG. 5 illustrates a schematic diagram of an example input processing approach that leverages multiple chains of prompt systems according to example implementations of aspects of the present disclosure;

FIG. 6 illustrates an example multi-threaded environment for implementing an agent system according to example implementations of aspects of the present disclosure;

FIGS. 7-9 are flow chart diagrams illustrating example methods for implementing an agent system according to example implementations of aspects of the present disclosure;

FIG. 10 is a flow chart diagram illustrating an example method for training a machine-learned model according to example implementations of aspects of the present disclosure;

FIG. 11 is a block diagram of an example processing flow for using machine-learned model(s) to process input(s) to generate output(s) according to example implementations of aspects of the present disclosure;

FIG. 12 is a block diagram of an example sequence processing model according to example implementations of aspects of the present disclosure;

FIG. 13 is a block diagram of an example technique for populating an example input sequence for processing by a sequence processing model according to example implementations of aspects of the present disclosure;

FIG. 14 is a block diagram of an example model development platform according to example implementations of aspects of the present disclosure;

FIG. 15 is a block diagram of an example training workflow for training a machine-learned model according to example implementations of aspects of the present disclosure;

FIG. 16 is a block diagram of an inference system for operating one or more machine-learned model(s) to perform inference according to example implementations of aspects of the present disclosure;

FIG. 17 is a block diagram of an example networked computing system according to example implementations of aspects of the present disclosure;

FIG. 18 is a block diagram of an example computing device according to example implementations of aspects of the present disclosure; and

FIG. 19 is a block diagram of an example computing device according to example implementations of aspects of the present disclosure.

### DETAILED DESCRIPTION

The present disclosure describes computer systems and methods for implementing an agent system with improved performance. The agent system can be an artificial intelligence (“AI”) agent. The agent system can utilize machine-learned models and AI-enabled systems to help users solve tasks. For instance, the agent system can employ one or more machine-learned models to generate outputs responsive to queries from users. As one example, an agent system can be or can include a computing system including one or more machine-learned models, where the computing system is configured to receive an input from a user device or calling device and provide an output responsive to the input to the user device or calling device. The agent system can be or can implement a multi-modal agent (e.g., a multi-modal artificial intelligence agent). For instance, a multi-modal agent can process inputs from one or more data modalities. In some implementations, the agent system can be implemented as a “situated agent”. The term situated agent refers to a setting in which the agent system shares one or more perceptual inputs with a human user. For example, the situated agent can receive and process various data inputs, including video, audio, and/or textual data which are also observable by the human user. The agent system can process these inputs to generate responses that are contextually-relevant for the user's physical or digital environment, for example enabling the agent system to generate dialogue or other responses or outputs which assist the user in understanding and/or navigating the environment.

The agent system can incorporate or benefit from a number of different aspects, including: the employment of advanced sequence processing models to enhance dialogue management, the integration of a real-time communication framework to facilitate immediate data exchange, architectural innovations that decouple input tokenization from model deployment, and/or an efficient caching strategy to optimize data flow. Additionally, the present disclosure provides techniques for accessing a user-specific memory layer to produce outputs responsive to user-specific tasks without increasing latency of the agent system.

These and other aspects of the present disclosure enhance the real-time responsiveness and contextual accuracy of the agent system. In particular, by providing advanced data processing architectures and efficient communication frameworks, aspects of the present disclosure improve system performance in dynamic environments. Specifically, the latency of responses from the agent system can be significantly reduced in cases of performing user-specific tasks.

According to one aspect of the present disclosure, some example implementations of the agent system can include or leverage sequence processing models to effectively process and respond to user interactions. For example, these models, such as large-language models (LLMs) and large-multimodal models (LMMs), can process a wide range of input data types, including textual, audio, and/or visual data. By integrating these diverse data types, the agent system can generate more contextually relevant responses that are configured to the specific situation and environment of the user.

In some implementations, the sequence processing models included in or used by the agent system can be specifically fine-tuned to manage different dialogue settings. This includes both turn-based dialogues, where the interaction follows a structured turn-taking pattern, and open dialogues, where any participant may speak at any time without a predefined turn order. This flexibility allows the agent system to adapt to various conversational scenarios, maintaining fluidity and coherence in its interactions regardless of the dialogue structure.

Agent systems (e.g., artificial intelligence agent systems) can perform a variety of tasks for users and devices that call (e.g., send a query to) the agent systems. In performing these tasks, the agent systems can access a variety of public-facing data sources to retrieve data responsive to the tasks. For instance, a user may ask an agent system to answer a user's factual question. The agent system may access various public-facing data repositories, such as web pages and databases, to generate an answer to the user's question. As another example, the user may ask the agent system to generate a phrase or some other content. For example, the agent system can serve various use cases that involve informing, guiding, teaching, or even playing with the user. In some implementations, the agent system can inform users about their immediate surroundings or provide detailed explanations on specific topics, enhancing everyday interactions with contextual intelligence. For example, while navigating an unfamiliar city, the agent system can offer historical facts and relevant details about visible landmarks. Additionally, the agent system can guide users through complex processes or procedures, such as assembling furniture or preparing recipes, by providing step-by-step instructions configured to the user's pace and progress and accounting for the current state of the user's performance of the task. For example, the agent system can provide synchronized visual and verbal instructions tailored to the user's progress. As another example, the agent system can teach users the underlying principles of a skill, such as playing a musical instrument, enabling them to generalize this knowledge to new situations independently. As yet another example, the agent system can analyze code displayed on a screen, identify problematic areas, and suggest optimizations or bug fixes.

These tasks can be characterized as user-agnostic tasks. In these user-agnostic tasks, the agent system can perform these tasks using entirely public-facing data. The exact manner in which the answer to a user-agnostic task is presented to the user may differ depending on, for example, the selected language of the user, previous interactions between the user and the agent system, and other factors affecting the communication between the user and the agent system. However, the fundamental elements of the task, such as the answer to a question asked by the user, may be determined entirely through the public-facing data.

In addition to user-agnostic tasks, however, the agent system can desirably perform more personal, user-specific tasks that require some knowledge of user-specific information provided by the user to the agent system. As one example, a user may provide the agent system with a query such as “What is my vehicle identification number?” or “Find a picture of my spouse.” The user may speak the query, input the query as text data, or provide the query to the agent system in any other suitable manner, such as, for example, by pointing to a written representation of the question and query the agent system with a prompt such as “Answer the question I am pointing to right now.” An agent system generally cannot perform these user-specific tasks using exclusively conventional public-facing data sources. For example, the agent system may not be able to properly evaluate the meaning of “my vehicle identification number” or “my spouse” as it applies to the given user.

Example aspects of the present disclosure can provide for agent systems to perform user-specific tasks through the inclusion of a user-specific memory layer. The user-specific memory layer can provide for the agent system to perform user-specific tasks for the user that can involve accessing data in the user-specific memory layer. The user-specific memory layer can provide for the agent system to access user-specific data, such as image data, video data, documents, and other data provided by the user to the agent system. As one example, the user-specific memory layer can access data at a designated local repository on a calling device belonging to the user. As another example, the user can provide the agent system with access instructions for user-specific data streams, such as video watch history, historical geodata, and other data that the user wishes for the agent system to have access to. As yet another example, in some implementations, the agent system can determine to store a data item in the user-specific memory layer. For example, if the agent system has access to a stream of video data, the agent system can determine (e.g., if prompted by the user) to store a portion of the video data in the user-specific memory layer. The user-specific memory layer can be, in some implementations, a long-term memory layer that can, with the consent of the user, provide context relating to long-term memories of the user, such as birthdays, anniversaries, and so on. Additionally or alternatively, the user can ask the agent system to store data in the user-specific memory layer, such as by asking the agent system to record and store video data from a camera of the user device. The user-specific memory layer may be, for example, a folder, directory, repository, cloud storage location, or other storage location dedicated to user-specific memory information.

As used herein, a “user” can refer to a number of different entities including, but not limited to, a person, an individual, a corporation or corporate user, a legal entity or other defined entity, an administrator, a system manager, a computer-implemented user (e.g., an agent system, a debug user or testing user, etc.), and/or other suitable users. Furthermore, a user can be associated with one or more accounts and/or an account can be associated with one or more users. For instance, an account may be associated with one or more individuals that have access to (e.g., manage) the account, and the user-specific memory layer may be associated with the individuals themselves and/or the account. For example, the user-specific memory layer associated with the account may be accessible to the account directly as a user, in addition to and/or alternatively to the individual(s) who manage or otherwise are associated with the account as user(s). As one particular example, one user can be a corporate entity associated with a corporate account, and one or more employees of the corporate entity can each be additional users that have access to the user-specific memory layer of the account associated with the corporate entity. As another example, a support account or administrative account associated with an entity may share access to some aspects of the user-specific memory layers of users associated with that entity.

Furthermore, in some implementations, a user or account can be associated with one or more profiles. For example, an account may have a first profile associated with personal use and a second profile associated with business use. The user-specific memory layer may be associated with the profile. For example, a user-specific memory layer associated with an individual's or account's first profile (e.g., a business profile) may not be accessible to an individual's or account's second personal profile (e.g., a personal profile). Additionally and/or alternatively, the user-specific memory layer may be associated with the individual or account itself. For example, a user-specific memory layer associated with a user may be accessible from a first profile (e.g., a business profile) and a second profile (e.g., a personal profile). In some implementations, these example aspects may be combined in a variety of combinations. For example, a user may be associated with a first user-specific memory layer associated with a first profile and a second user-specific memory layer associated with a second profile, each of which is inaccessible by the other profile, and a third user-specific memory layer that is associated with the user (e.g. the user's account) directly such that it is accessible to both the first profile and the second profile.

Using the user-specific memory layer to determine every query, however, can complicate the analysis of user-agnostic queries. For instance, including user-specific memory information in certain user-agnostic tasks can increase the latency of the agent system, unnecessarily include user-specific information, or decrease accuracy of outputs. According to the present disclosure, to solve this technical issue, a routing mechanism or routing tool can be employed by the agent system to determine whether to route the agent system to public-facing data interfaces or the user-specific memory layer based on what information is required to respond to the query. For instance, the routing mechanism or routing tool can be designed, trained, or otherwise configured to determine which tasks and queries involve the user-specific memory layer. As one example, the agent system can invoke the routing mechanism by a routing prompt based on the query. The routing prompt can provide information relevant to the routing mechanism such that the routing mechanism can decide how to perform the task (e.g., using user-specific information). The routing prompt may include the query itself and/or additional data related to the user, the query, and other relevant information. In some implementations, the agent system can train a routing tool by curating training data from historical prompts of the agent system (e.g., by unsupervised learning). When the routing mechanism or routing tool identifies that a query invokes one of these user-specific tasks, the agent system can retrieve data from the user-specific memory layer and utilize that data to solve the task. If, however, the routing mechanism or routing tool identifies that the query does not invoke a user-specific task, the agent system can instead retrieve data from a public data interface (e.g., an API) for a public data source, such as a database or webpage. Additionally or alternatively, the agent system can perform the user-agnostic task using the unassisted capability of the agent system, such as by the functionality of a trained machine-learned model employed by the agent system.

The routing mechanism or routing tool may be a smaller model than the models of the agent system. For instance, the routing mechanism or routing tool may be a machine-learned model having fewer layers, fewer nodes, less training data, or other reduced resources relative to the machine-learned model(s) of the agent system. As another example, the routing tool can be a smaller version of the agent system.

Accessing the user-specific memory layer can, in some instances, involve parsing significant amounts of potentially disparate data items. In some implementations, the data items of the user-specific memory layer can be indexed. For instance, the data items can be pre-indexed prior to the user-specific memory layer being accessed by the agent system. As one example, indices of the data items can be generated based on embeddings of the data items. The agent system can generate a retrieval prompt to retrieve a set of data items from the user-specific memory layer. The set of retrieved data items can be produced by comparing the indices of the data items to the retrieval prompt. As one example, the retrieval prompt can be embedded, and the distance between the embedding of the retrieval prompt and the indices can be used to determine which items to retrieve. In some implementations, the agent system may further select a subset of data items to utilize in its output from the set of retrieved data items.

Once the agent system has retrieved the output data items utilized to generate its output, the agent system can generate an output responsive to the task requested by the query from the calling device. For example, the output of the agent system can answer a user-specific question using data from the user-specific memory layer. As one example, if the query asks the agent system to retrieve photos of a user's spouse, the agent system can provide one or more images depicting the user's spouse from the user-specific memory layer. As another example, if a user asks the agent system when the user's anniversary is, the agent system can retrieve date information from photos of the user and the user's spouse that seemingly depict a wedding, calendar data, and so on. As yet another example, if the user asks the agent system what the user's vehicle identification number is, the agent system can extract text data containing the vehicle identification number from a retrieved image of a portion of the user's vehicle containing the vehicle identification number. The output from the agent system may also include a phrase responsive to the query, such as text confirming the subject of the output (e.g., “Sure, here is a photo of your spouse:”). The output from the agent system can be provided to the calling device used to call the agent system.

Additionally or alternatively, in some implementations, the agent system can include or have access to a model memory layer that enables the storage and retrieval of various types of information relating to current and/or previous usage of the agent system. This can include past interactions, observations, preferences, and/or environmental data. The agent system can utilize this stored information to generate new predictions, outputs, or actions, effectively using historical data to inform and improve its real-time responses and decision-making processes. In some implementations, the model memory layer can be a separate memory layer from the user-specific memory layer. For example, in some implementations, the model memory layer may be stored in a first memory location (e.g., at a server in communication with the agent system) and the user-specific memory layer may be stored in a second memory location (e.g., in a local memory of a calling device of the user).

Various types of data can be stored in the model memory layer to support the operations of the agent system. Object detections, for example, can include indexed records of objects encountered, complete with metadata like timestamps and location coordinates, which help the agent system recognize and recall objects across different sessions. Additionally, embeddings of observed visual or textual content can be stored, providing low-dimensional representations that facilitate rapid data retrieval and recognition tasks. The memory can also hold intermediate model activations and/or raw tokens from the processing activities of the agent system, providing for the agent system to resume or adjust ongoing tasks efficiently and reconstruct input sequences over time.

The memory of the agent system can be divided into short-term and long-term components, with the former handling recent interactions and the latter storing more permanent, valuable data such as user preferences and historical interactions. This system can support both structured and unstructured data and can employ advanced indexing and search algorithms to facilitate quick and relevant data retrieval based on various parameters. Contextual memory retrieval mechanisms enhance the responsiveness of the agent system by retrieving pertinent information based on the current environment or past locations visited by the user.

The integration of a dynamic and robust memory layer within the agent system enhances the utility of the agent system. By maintaining a repository of diverse data types, the agent system can perform context-aware computing, where the context spans some “history” or prior observations or interactions. This capability enables the agent system to deliver accurate and contextually relevant responses based on an understanding of past data and environmental contexts.

Example aspects of the present disclosure can provide a number of technical effects and benefits, including improvements to computing technology. As one example, the systems and methods according to example aspects of the present disclosure can provide for enabling computing systems to perform a variety of user-specific tasks, such as answering user-specific questions or retrieving user-specific information, which would be difficult or impossible using conventional systems. As another example, the inclusion of a routing tool or routing mechanism can decrease computing resource usage associated with performing a task by an agent system. For example, the routing tool can determine whether to access a user-specific memory layer of the agent system. In contrast to, for example, accessing the user-specific memory layer in response to each query from a user, the routing tool can access the user-specific memory layer only when it will be beneficial for performing the task. Furthermore, in some implementations, the routing tool can be a smaller agent or model than the agent system. The smaller routing tool can require fewer computing resources to evaluate than the entire agent, thereby saving computing resources associated with determining how to perform a user-specific task. For example, the agent system is not required to evaluate a user-specific task using its entire computing capability simply to determine that it will not produce a confident output in response to the user-specific task. Furthermore, in some implementations, the inclusion of the user-specific memory layer can reduce computing resources required to train the agent system. For example, the inclusion of the user-specific memory layer can provide for the agent system to perform user-specific tasks without requiring the agent system to be trained using user-specific data. This can prevent additional training cycles associated with training the agent system on user-specific data.

Furthermore, example aspects of the present disclosure can protect user privacy of users of agent systems. For instance, the user-specific memory layer can provide for the agent system to perform user-specific tasks without requiring the agent system to be trained using user-specific data. The agent system may therefore be responsive to user-specific tasks without being required to transmit the user-specific data across one or more networks for training the agent system. Additionally or alternatively, in some cases, the user-specific memory layer may be partially or entirely maintained at a local, private data repository (e.g., in local memory of a user device) such that the user-specific data is not exposed to external data interfaces.

Various example implementations are described herein with respect to the accompanying FIGS.

### Example Agent Systems and Architectures

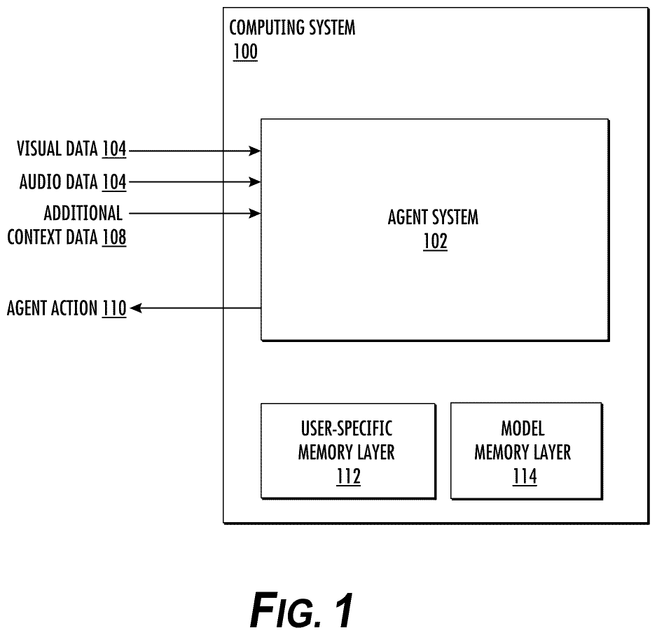

Referring now to FIG. 1, a block diagram illustrates an example computing system 100 configured to implement an agent system 102, according to example implementations of aspects of the present disclosure. The depicted computing system 100 is designed to receive multiple types of input data, process this data, and generate outputs that are responsive to the inputs in a contextually appropriate manner.

The agent system 102 within the computing system 100 is configured to receive visual data 104, audio data 106, and additional context data 108. Each type of data is processed by the agent system 102 to facilitate interaction within its operational environment. For example, visual data 104 can include live video streams from a camera or recorded video streams from a web resource, while audio data 106 can include spoken commands or ambient sounds captured by microphones.

Additional context data 108 can include sensor data, textual information, or other forms of digital data that provide further insights into the environment or the context of the interaction. As one example, the additional context data 108 can include sensor data that captures user inputs beyond speech inputs, such as touch-screen inputs, gestures, facial expressions, and/or other inputs. These user inputs can, in some implementations, be merged with other inputs such as visual data 104 to create combined inputs. In one example, a user can be provided with an interface that displays a real-time field of view of the agent system (e.g., which may correspond to visual data 104). The interface can enable the user to “draw” on or otherwise interact with the interface to mark up the real-time field of view. For example, the user could draw an arrow or make a circle to identify a particular object included within the scene displayed on the interface. The user's graphical input can be added onto or merged with the visual data 104 to form a combined input. For example, the visual data 104 can be amended to include the arrow or circle, which can then be processed by the agent system 102. In such manner, interactive interfaces can provide the ability for the user to more granularly interact with or identify portions of the environment when querying the agent system 102.

Furthermore, it should be appreciated that in some cases the user will be able to control the type, nature, content, or other characteristics of the visual data 104, audio data 106, and/or additional context data 108. As one example, the user can manipulate a field of view of a camera to alter the content of the visual data 104 that is provided to the agent system 102. Similarly, by speaking into a microphone, the user can provide additional audio data 106 as an input for the agent system 102. The agent system's ability to process and combine visual, auditory, and textual information allows it to generate more comprehensive and nuanced responses, carefully tailored to the user's multi-modal context.

The agent system 102 processes these diverse inputs to generate an agent action 110, which can include an output designed to respond to the processed inputs effectively. As examples, this action can range from textual responses, vocal responses, displaying information, controlling connected devices, or any other form of interaction output that is deemed appropriate based on the input data. Specifically, the agent system 102 can provide concise answers, generate detailed explanations, offer step-by-step instructions, display information through visual highlights or augmented reality overlays, control connected devices, and/or other forms of actions 110.

In some implementations, the agent system 102 can include and use specialized sequence processing models to integrate and analyze the input data. These models are configured to process complex patterns across different data modalities, enabling the agent system 102 to generate more accurate and contextually relevant responses. The sequence processing models may be specifically fine-tuned to handle various interaction dynamics, such as turn-based dialogues or more open-ended conversational formats, enhancing the flexibility and adaptability of the agent system.

Furthermore, the computing system 100 can be connected to a real-time communication framework that facilitates the immediate and efficient exchange of data, including the inputs and outputs to and from the agent system 102. This configuration reduces latency in data processing and response generation.

The agent system 102 can include or can have access to a user-specific memory layer 112. The user-specific memory layer 112 can provide for the agent system to access user-specific data, such as image data, video data, documents, and other data provided by the user to the agent system. As one example, the user-specific memory layer 112 can access data at a designated local repository on a calling device belonging to the user and/or other memory within the computing system 100 or accessible by the computing system 100. For example, the user-specific memory layer can be a directory, folder, file repository, or other non-tangible, computer-readable media in which the user consents to store video data, pictures or image data, documents, files, music or audio data, or other computer-readable data that the user wishes for the agent system 102 to have access to. Additionally or alternatively, the user can ask the agent system 102 to store data in the user-specific memory layer 112, such as by asking the agent system 102 to record and store video data from a camera of the user device. For example, the user may instruct the agent system 102 to “remember where I parked,” in response to which the agent system 102 may capture image data and/or geopositional data of a vehicle of the user. As another example, the user may instruct the agent system 102 to “remember that for later,” in which case the agent system 102 may capture image data or video data of the environment at which the user is looking (e.g., through a camera on a wearable device, such as smart glasses).

As another example, the user can provide the agent system 102 with access instructions for user-specific data streams, such as video watch history, historical geodata, and other data that the user wishes for the agent system 102 to have access to, which can either be or can provide data to the user-specific memory layer 112. The user-specific memory layer 112 can be, in some implementations, a long-term memory layer that can, with the consent of the user, provide context relating to long-term memories of the user, such as birthdays, anniversaries, and so on.

In some implementations, in addition to the user-specific memory layer 112, the agent system 102 can include or have access to a model memory layer 114 or other memory system. The agent system 102 can store and retrieve various types of information to and from the model memory layer 114. For example, the agent system 102 can store past interactions, observations, preferences, and/or information from the environment in the model memory layer 114. The agent system 102 can then recall this information for use in generating new predictions, outputs, or agent actions.

A number of different types of data can be stored in the model memory layer 114. One example of data stored within the model memory layer 114 can include object detections. This can include indexed records of objects that the agent system encounters during its operations, complete with metadata such as timestamps, location coordinates, and/or contextual tags. By archiving these detections, the agent system 102 can recognize and recall objects from a “history” of observed scenes. The agent system 102 can leverage this information to refine interactions and bolster situational awareness, potentially spanning different sessions of user interaction.

As another example data type, the model memory layer 114 can store embeddings of observed visual content, textual content, or other inputs. These embeddings can be low-dimensional numerical representations that encode the essential features of input data into a latent embedding space. The storage of embeddings associated with observed inputs allows the agent system 102 to conduct rapid comparisons and recognition tasks efficiently. In particular, these embeddings, which can be derived from various layer(s) of the agent system's machine-learned models, can be used to perform similarity searches to facilitate quick data retrieval.

As another example, intermediate model activations can be stored in the model memory layer 114. Capturing and preserving the state of model activations at various stages can enable the agent system 102 to efficiently resume or adjust its processing activities as needed. This feature can be used in scenarios involving long-running or complex processing tasks that may be interrupted or require dynamic adjustments such as resetting the agent system to a prior state associated with a prior time.

As another example, the model memory layer 114 can store raw tokens generated by the agent system's natural language processing, image processing, or other tokenization mechanisms. For example, a cache of tokens can be stored, with each being associated with a specific timestamp. This data allows for the reconstruction of the sequence of inputs and internal states over time, which can be used to retrieve and replay perceptual inputs associated with a particular timestamp or setting, or to otherwise provide the raw tokens as a contextual input for a later prediction.

By maintaining a repository of these data types, the agent system 102 can be equipped with a knowledge base that supports advanced functionalities such as context-aware computing, personalized interactions, and information retrieval from past observations. For example, upon retrieving stored information from the model memory layer 114, the agent system 102 can integrate the retrieved data into the current processing workflow. This integration can include aligning historical and current data to enhance the accuracy and relevance of the output.

In some implementations, the agent system 102 can include or have access to both short-term and long-term memory components. The short-term memory may be volatile, designed for the temporary storage of recent interactions and sensory inputs. In contrast, the long-term memory may be non-volatile, storing valuable learned information, user preferences, historical interaction data, and significant environmental events for longer-term recall and usage. In addition, the design of the model memory layer 114 can accommodate both structured and unstructured data. As an example, for immediate processing needs, volatile memory such as Random Access Memory (RAM) can be used. As another example, for the purpose of long-term data retention, non-volatile storage solutions such as Hard Disk Drives (HDDs) or Solid-State Drives (SSDs) can be used. Furthermore, the model memory layer 114 can include hybrid memory solutions that combine the rapid access capabilities of RAM with the extensive storage capacity of disk storage, thereby optimizing the performance of the agent system 102 across various tasks.

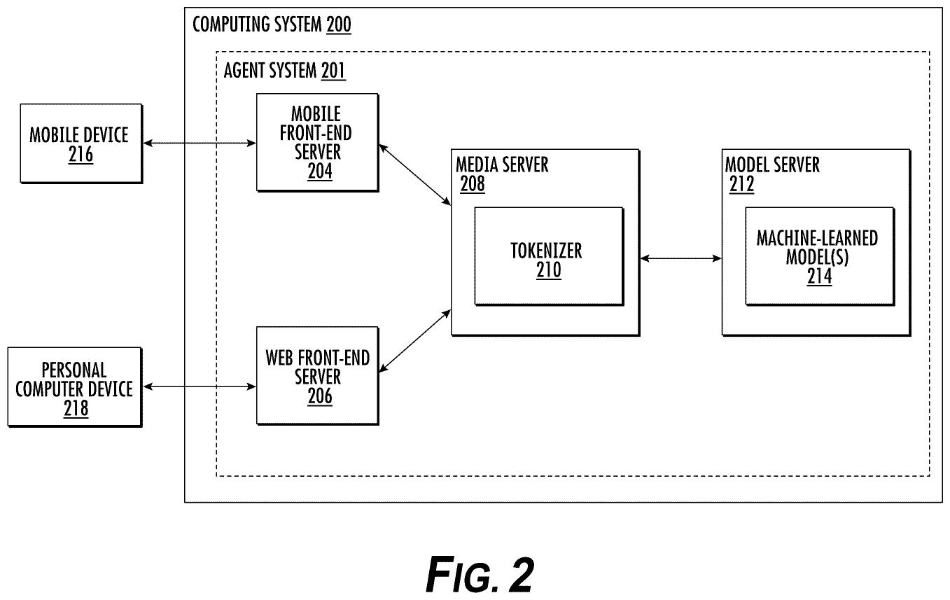

Referring now to FIG. 2, a block diagram illustrates an example computing system 200 configured to implement an agent system 201, according to example implementations of aspects of the present disclosure.

The agent system 201, which is implemented by the computing system 200, can be configured to interface with different types of client devices, including mobile device 216 and personal computer device 218. These devices can send and receive data to and from the agent system 201, allowing for a dynamic interaction between the user and the agent system.

The computing system 200 includes several components that facilitate the operation of the agent system 201. The mobile front-end server 204 and the web front-end server 206 represent the interfaces through which mobile and web-based interactions respectively occur. These servers manage the initial reception of input data from the mobile device 216 and the personal computer device 218, preprocessing this data as necessary before forwarding it to the media server 208.

The media server 208 can act as a central hub within the architecture, receiving processed inputs from both the mobile front-end server 204 and the web front-end server 206. One of the functions of the media server 208 can be to manage the flow of multimedia data, such as video and audio streams, which serve as inputs for the multi-modal capabilities of the agent system 201.

The media server 208 can include a tokenizer 210. The tokenizer 210 can operate to process the incoming multimedia data. For example, the tokenizer 210 breaks down complex data streams into manageable tokens, which are simpler data units that can be more easily processed by machine learning models.

From the media server 208, these tokens are then transmitted to the model server 212, which includes and runs one or more machine-learned models 214. These models 214 are responsible for analyzing the tokens to generate responses that are contextually-appropriate based on the input data. The model server 212 operates asynchronously with the tokenizer 210, ensuring that the tokenization process does not delay the response generation, thus maintaining low latency and high responsiveness of the agent system 201. Stated differently, the timing of the operations of the tokenizer 210 and the model server 212 can in general be established with less interdependence than if the operations of the tokenizer 210 and the model server 212 were sequentially performed by the same machine or machine cluster.

The architecture illustrated in FIG. 2 supports the efficient processing of data by decoupling the roles of front-end processing and model execution. This decoupling allows the system to optimize performance by parallelizing tasks and minimizing the processing time from input reception to response generation. The use of separate servers for handling different aspects of the data flow—front-end interaction, media processing, and model inference—enhances the system's ability to scale and manage large volumes of interactions simultaneously.

Furthermore, in some implementations, the mobile front-end server 204 and the web front-end server 206 can be specifically configured to support WebRTC protocols or other real-time communication frameworks. This configuration allows these servers to establish peer-to-peer connections with the client devices, facilitating direct data transfer paths that bypass traditional server relay methods. By using WebRTC, the system minimizes the latency typically associated with data transmission over the internet, enhancing the responsiveness of the agent system 201.

Additionally, the media server 208 can be equipped with specialized software components that handle the WebRTC streams. These components can include signal processing units that manage the real-time encoding and decoding of video and audio streams, ensuring that the data remains synchronized and maintains high quality throughout the transmission process. The integration of these components allows the media server 208 to efficiently manage the flow of multimedia data, preparing it for further processing by the tokenizer 210 and eventually the model server 212.

In the architecture illustrated in FIG. 2, the term “server” encompasses a broad range of configurations, each potentially include one or more machines. This includes setups where a server may represent a cluster of machines working collectively to handle specific tasks or workloads. Additionally, the machines involved in such configurations can be either physical machines, consisting of tangible hardware components, or virtual machines, which operate within a controlled software environment on a physical server.

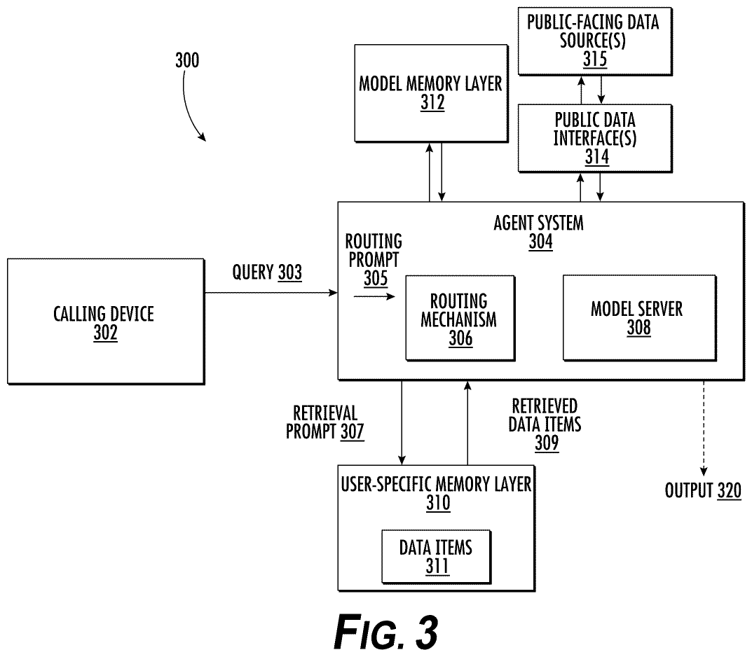

FIG. 3 illustrates a block diagram of an example system 300 according to example implementations of aspects of the present disclosure. The system 300 can include a calling device 302. The calling device 302 can be operated by a user to provide a query 303 to an agent system 304. For instance, the calling device 302 can provide the query 303 to the agent system 304 over one or more networks (not illustrated). The calling device 302 can be any suitable computing device, such as, for example, a mobile phone, a mobile computing device such as a laptop computer, a stationary computing device such as a desktop computer or server computing system, a wearable computing device such as those incorporated into smart watches or smart glasses, or other suitable computing device.

The agent system 304 can be or can include any suitable agent system. For example, the agent system 304 can be an artificial intelligence (“AI”) agent. The agent system 304 can utilize machine-learned models and AI-enabled systems to help users solve tasks. For instance, the agent system 304 can employ a model server 308 having one or more machine-learned models to generate outputs responsive to the query 303 from the user. In some implementations, the model server 308 can be, can include, or can be included in the model server 212 of FIG. 2. As one example, the agent system 304 can be or can include a computing system including one or more machine-learned models, where the computing system is configured to receive an input from the calling device 302 and provide an output 320 responsive to the input. The output 320 can be provided to the calling device 302 and/or another computing system.

The agent system 304 can include a routing mechanism 306 configured to determine whether the query 303 is a user-specific query directed to a user-specific task. The routing mechanism 306 can be a portion of, module of, subsystem of, or otherwise included in the agent system 304, such as illustrated in FIG. 3. Additionally or alternatively, the routing mechanism 306 can be accessible by but remote from the agent system 304. For example, in some implementations, the agent system 304 and the routing mechanism 306 may be implemented by a same computing device. Additionally or alternatively, in some implementations, the agent system 304 and the routing mechanism 306 may be implemented by two or more computing devices in communication over one or more networks.

The agent system 304 can generate a routing prompt 305 and provide the routing prompt 305 as input to the routing mechanism 306. The routing prompt 305 can instruct the routing mechanism 306 to classify the query 303 as a user-specific query or a user-agnostic query. For example, the routing prompt 305 can include instructions that instruct the routing mechanism 306 to produce an output. The routing mechanism 306 may be, for example, a general purpose machine-learned model or a “lightly” fine-tuned machine-learned model having minimal task-specific training. For example, a lightly fine-tuned model may be obtained as a general purpose model configured for a variety of related tasks and subjected to a training process directed to a specific task (e.g., routing) that is less rigorous than a training process that would typically be required to train a model from scratch (e.g., from neutral values) for the specific task. Additionally or alternatively, in some implementations, the routing prompt 305 may not necessarily include explicit instructions for the routing mechanism 306. As one example, the routing mechanism 306 may be or may include a “heavily” fine-tuned or otherwise specialized model specifically configured for routing the query 303.

The routing mechanism 306 can produce an output indicative of determining to access a user-specific memory layer 310 of the agent system 304. For instance, the agent system 304 can determine to access the user-specific memory layer 310 of the agent system based on an output of the routing mechanism 306 in response to the routing prompt 305. As one example, the routing mechanism 306 can produce an output including a classification of the query 303 as a user-specific query requesting a user-specific task or a user-agnostic query requesting a user-agnostic task. The agent system 304 can determine to access the user-specific memory layer 310 if the query 303 is a user-specific query and/or determine to instead access one or more public data interface(s) 314 if the query 303 is a user-agnostic query. For instance, determining to access the user-specific memory layer 310 can be at least partially dependent on whether or not the task can be adequately performed with public information, training data, model resources, and so on. The public data interface(s) 314 can be, for example, application programming interfaces (“APIs”), web portals, or other interfaces that provide access to one or more public-facing data source(s) 315. Example public-facing data sources 315 include a public database and a public encyclopedia.

The user-specific memory layer 310 can be any suitable virtual location or interface that stores, interfaces with, or otherwise provides access to one or more data items 311 descriptive of user-specific information. The user-specific information and/or the data items 311 can, for example, include files, images, video data, documents, historical computing system usage, or other data items that the user has placed into access via the user-specific memory layer. For instance, in some implementations, the user-specific memory layer can be, can include, or can otherwise provide access to a local storage of the calling device 302, a cloud storage directory associated with a user, a network-accessible directory hosted on local hardware accessible by the user, a temporary storage or permanent storage of the agent system 304 (e.g., uniquely) associated with the user, or other suitable virtual location or interface.

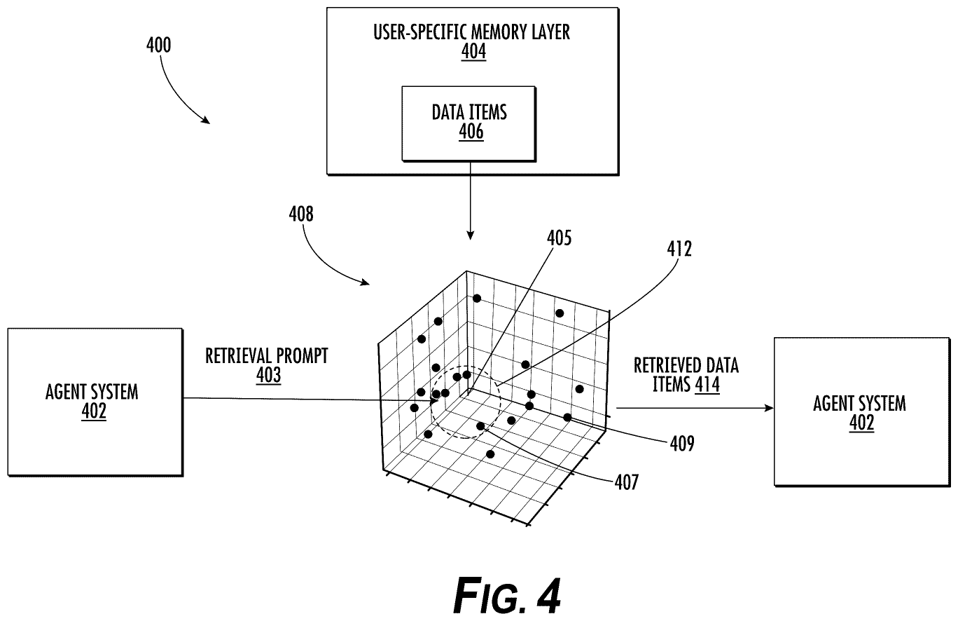

The agent system 304 can generate a retrieval prompt 307 based on the query 303 and/or the output of the routing mechanism 306. The retrieval prompt 307 can be a message or instruction that, when communicated and/or implemented by the agent system 304, causes the retrieval of information including one or more retrieved data items 309 from the user-specific memory layer 310. The agent system 304 can generate the output 320 using the user-specific memory layer 310 and based on the retrieval prompt 307. For instance, the agent system 304 can produce output 320 such that the output 320 incorporates or otherwise is affected by the retrieved data items 309. In some implementations, the retrieved data items 309 can be selected based on a comparison between the retrieval prompt 307 and the data items 311. For example, in some implementations, the data items 311 are indexed, and indices of the data items 311 are compared to the retrieval prompt 307 to select the retrieved data items 309. One example approach for retrieving the retrieved data items 309 is described more particularly with respect to FIG. 4.

FIG. 4 illustrates a block diagram of an example system 400 according to example implementations of aspects of the present disclosure. The system 400 depicts an embedding-based approach for retrieving data items by an agent system 402 from a user-specific memory layer 404. Some or all of the agent system 402, the retrieval prompt 403, the user-specific memory layer 404, the data items 406, and the retrieved data items 414 can be similar to or the same as the agent system 304, the retrieval prompt 307, the user-specific memory layer 310, the data items 311, and the retrieved data items 309 of FIG. 3, except as otherwise indicated.

The agent system 402 can generate a retrieval embedding 405 based on the retrieval prompt 403. For instance, the retrieval embedding 405 can be generated by projecting the retrieval prompt 403 into a multidimensional embedding space 408. In addition to the retrieval embedding 405, respective embeddings of one or more data items 406 in the user-specific memory layer 404 can be projected into the embedding space 408. The data items 406 in the user-specific memory layer 404 can be indexed by their respective embeddings. Although the embedding space 408 is illustrated as a three-dimensional space for the sole purpose of clarity in illustration, it should be understood that the embedding space 408 can be n-dimensional, where n is any positive whole number (excluding zero). As examples, n can be, but is not limited to, 128, 256, 1024, or other suitable number.

An arbitrary data item can map to a set of discrete locations in the embedding space 408. As an example, an arbitrary data item, such as the retrieval prompt 403 and/or the data items 406 of the user-specific memory layer 404 can be mapped or projected into the embedding space 408 through a projection algorithm that reduces the data item to values of one or more coordinates of dimensions in the embedding space 408. For instance, elements that correspond to discrete members of a predetermined vocabulary of tokens can map to discrete locations in the embedding space 408 that are associated with those tokens. Other elements can be continuously distributed across the embedding space 408. For instance, some data types can be broken down into continuously defined portions (e.g., image patches) that can be described using continuously distributed locations within the embedding space. Relationships between elements can be represented or even inferred based on distances between the respective embeddings of the elements in the embedding space 408. For example, if the data items 406 and the retrieval prompt 403 both contain text-derived tokens, the distance between the retrieval embedding 405 and the respective embeddings

In some implementations, the expressive power of the embedding space 408 may not be limited to meanings associated with any particular set of tokens or other building blocks. For example, a continuous embedding space can encode a spectrum of high-order information. An individual piece of information (e.g., a token) can map to a particular point in that space 408: for instance, a token for the word “dog” can be projected to an embedded value that points to a particular location in the embedding space associated with canine-related information. Similarly, an image patch of an image of a dog on grass can also be projected into the embedding space 408. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

The retrieved data items 414 can be selected and provided to the agent system 402 based on a distance between the retrieval embedding 405 and the respective embeddings of the data items 406. For instance, the distance between the retrieval embedding 405 and a respective embedding can be determined by an n-dimensional Euclidean distance, where n is the number of dimensions in the embedding space 408, or any other suitable distance measurement technique. As an example, a first data item 406 where the distance between the retrieval embedding 405 and a first respective embedding 407 of the first data item 406 satisfies (e.g., is less than or is less than or equal to) a distance threshold (depicted solely for illustrative purposes by dashed circle 412 in FIG. 4), can be selected and included in the set of retrieved data items 414. Additionally or alternatively, a second data item 406 where the distance between the retrieval embedding 405 and a second respective embedding 409 of the second data item 406 does not satisfy (e.g., is greater than or is greater than or equal to) the distance threshold can not be selected and included in the set of retrieved data items 414. In the visual depiction of FIG. 4, for instance, the data items 406 with embeddings inside the dashed circle 412 can be included in the set of retrieved data items 414, and the data items 406 with embeddings outside the dashed circle 412 can not be included in the set of retrieved data items 414.

In embedding spaces of increasing n-dimensionality, the distance threshold can resemble an n-sphere. Furthermore, in some implementations, the distance threshold can be or include either or both of an overall distance threshold and/or a sub-dimension threshold(s). For instance, the overall distance threshold can define a minimum and/or maximum overall (e.g., Euclidean) distance, such as in the example shown by dashed circle 412, while the sub-dimension threshold(s) can apply to distances projected onto a subset of all n dimensions of the embedding space 408, including, for instance, a single dimension.

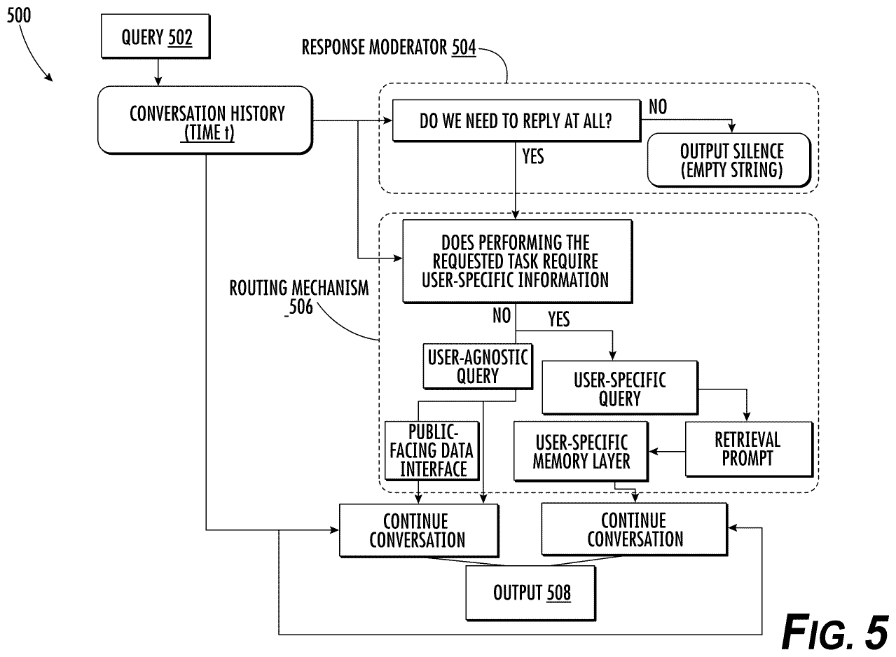

Referring now to FIG. 5, a schematic diagram 500 illustrates an example input processing approach that leverages multiple chain-of-prompt-based systems according to example implementations of aspects of the present disclosure. This diagram presents a detailed view of one example decision-making process within an agent system in response to a query 502, demonstrating how various components interact to process and respond to user-specific queries effectively.

FIG. 5 illustrates a response moderator 504, which serves as the initial decision point in the processing flow. The response moderator 504 evaluates the conversation history at a given time (time t) to determine whether a response from the agent system is necessary. If the moderator decides that no reply is needed, it outputs silence, represented by an empty string, thereby avoiding unnecessary or distracting interactions. In some implementations the response moderator 504 can be implemented by prompting a sequence processing model.

If a response is deemed necessary, the system then evaluates whether user-specific information is required to formulate the response. This decision can be facilitated by the routing mechanism 506, which can generate routing prompts based on the classification of the query 502 as a user-specific query needing user-specific information or a user-agnostic query that does not need user-specific information. If user-specific information is needed, the routing mechanism 506 instructs the agent system to generate a retrieval prompt for retrieving information from a user-specific memory layer. If the query 502 is user-agnostic, however, the routing mechanism 506 can instruct the agent system to access a public-facing data interface or simply answer directly without external data inputs. In some implementations, the classification and routing prompt generation tasks of the routing mechanism 506 can be performed by a sequence processing model. The agent system can ultimately produce an output 508 responsive to the query 502 while maintaining a conversational dynamic with the user.

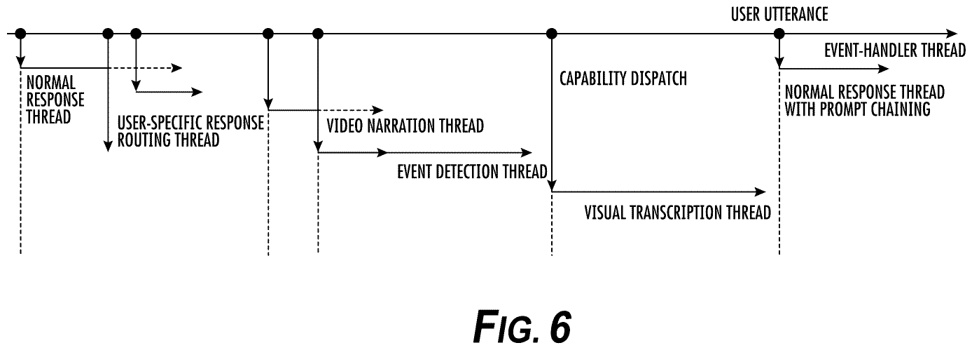

Referring now to FIG. 6, a schematic diagram illustrates an example multi-threaded environment for implementing an artificial intelligence agent, according to example implementations of aspects of the present disclosure. In the illustrated environment, multiple threads are deployed, with each thread configured to handle specific types of tasks or data processing needs.

The diagram depicts several example threads: a normal or base response thread, a user-specific response routing thread, a video narration thread, an event detection thread, a visual transcription thread, and an event-handler thread, each connected through dispatch mechanisms that determine the flow of operations based on the context of the interaction and the specific needs at that moment.

Normal Response Thread: This thread manages standard interactions with the user, processing inputs such as queries or commands and generating appropriate responses. The thread can operate independently or in conjunction with other threads to ensure that the user receives timely and contextually relevant information.

User-specific Response Routing Threat: This thread processes user inputs to determine whether tasks requested by the user inputs are user-specific or user-agnostic. If the tasks are user-specific, this thread can output instructions to the agent system to access a user-specific memory layer for performing the tasks. As an example, this thread can implement the routing mechanism described herein as a parallel thread of a multi-threaded agent system. For example, the routing mechanism can operate through this thread while other threads handle other precursory tasks, such as identifying modality, event detection, and similar tasks.

Video Narration Thread: This thread is activated when there is a need to narrate or describe video content being analyzed by the agent system. This thread can be particularly useful in scenarios where visual content is requested to be explained or discussed with the user.

Event Detection Thread: This thread can perform proactive event detection within the agent system's operational environment. It can continuously monitor input data streams for specific events or changes that require immediate attention or action. This thread enables the agent system to initiate responses or alerts autonomously, without waiting for a direct user prompt.

Visual Transcription Thread: This thread handles the transcription of visual data into a textual or descriptive format that can be easily integrated into the agent system's responses.

Event-Handler Thread: The event-handler thread manages the integration of responses generated by other threads into a coherent output that is presented to the user. This thread can ensure that all responses, whether generated from standard interactions, video narration, or event detection, are synchronized and delivered in a manner that maintains the flow and context of the ongoing interaction.

### Example Methods

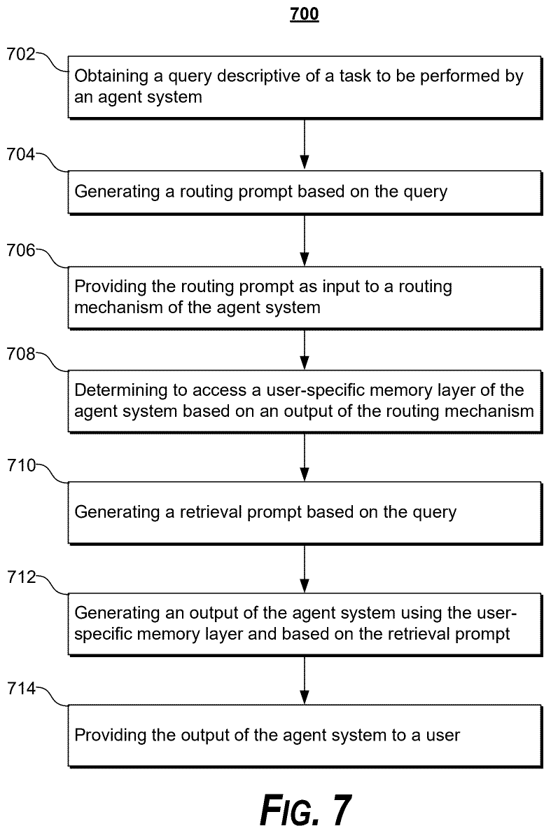

FIG. 7 depicts a flowchart of a method 700 for implementing agent systems according to aspects of the present disclosure. For instance, an example agent system can include one or more machine-learned models and/or other systems configured to perform tasks in response to a query from a user.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, the method 700 can include obtaining (e.g., by a computing system including one or more computing devices) a query descriptive of a task to be performed by an agent system. The agent system can be or can include any suitable agent system. For example, the agent system can be an artificial intelligence (“AI”) agent. The agent system can utilize machine-learned models and AI-enabled systems to help users solve tasks. For instance, the agent system can employ one or more machine-learned models to generate outputs responsive to queries from users. As one example, an agent system can be or can include a computing system including one or more machine-learned models, where the computing system is configured to receive an input from a user device or calling device and provide an output responsive to the input to the user device or calling device. The agent system can be or can implement a multi-modal agent (e.g., a multi-modal artificial intelligence agent). For instance, a multi-modal agent can process inputs from one or more data modalities. In some implementations, the agent system can be implemented as a “situated agent”. The term situated agent refers to a setting in which the agent system shares one or more perceptual inputs with a human user. For example, the situated agent can receive and process various data inputs, including video, audio, and/or textual data which are also observable by the human user. The agent system can process these inputs to generate responses that are contextually-relevant for the user's physical or digital environment, for example enabling the agent system to generate dialogue or other responses or outputs which assist the user in understanding and/or navigating the environment.

In some implementations, the query can be obtained from a calling device or user device associated with a user. For example, the user can provide the query and/or data associated with the query to the agent system through the calling device. As one example, the calling device can be a mobile device such as a mobile phone, smartphone, laptop computer, or other mobile device. As another example, the calling device can be a wearable computer, such as a smart watch, smart glasses, or other wearable computer. As another example, the calling device can be a stationary (e.g., non-mobile) computer, such as a desktop computer.

The query can be formatted in any suitable manner. In some implementations, the query can be or can include text data. For example, the query can be or can include text data having one or more characters that describe in written language the objective of the task to be performed. The query may generally resemble a spoken phrase. For example, in some implementations, the query can be spoken by a user. For example, a user can utter a phrase such as “Show me a picture of my spouse.” In some implementations, the spoken phrase can follow an activation word or phrase, such as “okay,” “hey,” an understood “name” of the agent system, a user-specified activation word or phrase, or any other suitable word or phrase. As yet another example, in some implementations, the query can be text data that is directly input by a user, such as by a keyboard, speech-to-text system, or other user input mechanism. In some implementations, the text data can be readily inputtable into the agent system. For example, the agent system can include one or more machine-learned models that are configured to receive text data or embeddings of text data as input.

The method 700 can include, at 704, generating (e.g., by the computing system) a routing prompt based on the query. Furthermore, at 706, the method 700 can include providing (e.g., by the computing system) the routing prompt as input to a routing mechanism of the agent system. The routing mechanism can be a portion of, module of, subsystem of, or otherwise included in the agent system. Additionally or alternatively, the routing mechanism can be accessible by but remote from the agent system. For example, in some implementations, the agent system and the routing mechanism can be implemented by a same computing device. Additionally or alternatively, in some implementations, the agent system and the routing mechanism can be implemented by two or more computing devices in communication over one or more networks.

In some implementations, the routing mechanism can be a routing tool of the agent system. For example, in some implementations, the routing tool is generated by the agent system to classify a query as one of a user-specific query or a user-agnostic query. A “tool” refers to an instance configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. As another example, a tool can have a machine-learned model with reduced model overhead compared to a larger machine-learned model. For instance, the model of the tool can be a less sophisticated model than the calling model that is specialized to a particular task or subset of tasks and can require fewer computing resources to produce a usable output. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem or for evaluation of simpler tasks that can be adequately performed by a less sophisticated model.

The routing mechanism or routing tool can be or can include a deterministic system and/or one or more machine-learned models. For example, in some implementations, the routing mechanism or routing tool can include a sequence processing model. The sequence processing model of the routing mechanism or routing tool can be a less complex model than the primary model(s) of the agent system. For example, in some implementations, the model of the routing tool can be a similar or same model type or format to the model(s) of the agent system, but can have fewer nodes, fewer layers, fewer input channels, or otherwise reduced complexity compared to the model(s) of the agent system. Additionally or alternatively, in some implementations, the model of the routing tool can have reduced training overhead compared to the model(s) of the agent system. For example, the model of the routing tool can be trained using fewer training examples, fewer iterations, or otherwise fewer resources devoted to training compared to the model(s) of the agent system.

In some implementations, the routing prompt can include metadata associated with the query. For instance, the routing prompt can be or can include the query itself and/or additional information about the user associated with the query, information or metadata about the query itself, or other suitable information. In some implementations, generating the routing prompt can include modifying the query and/or appending data to the query. For instance, in some implementations, the computing system can reword, reformat, or otherwise modify the query to arrive at the routing prompt. In some implementations, the routing prompt can be in a same modality as the query.

In some implementations, the routing prompt can be or can include an instruction prompt. For example, the instruction prompt can include instructions that instruct the routing mechanism to produce an output. The routing mechanism can be, for example, a general purpose machine-learned model or a “lightly” fine-tuned machine-learned model having minimal task-specific training. For example, a lightly fine-tuned model can be obtained as a general purpose model configured for a variety of related tasks and subjected to a training process directed to a specific task (e.g., routing) that is less rigorous than a training process that would typically be required to train a model from scratch (e.g., from neutral values) for the specific task. As one example, a routing tool having a less-powerful sequence processing model than the primary model(s) of the language system can receive instructions to format or guide the model in producing its output. As an example, if the routing mechanism is configured to interpret plain language, the instructions in the routing prompt may include phrases such as:
Determine whether the agent system will need to access user-specific information to perform the task requested by the user. Interpret the following as pairs of data classifications and values.
Output a one-word response including one of either “Yes” or “No.”

The query and/or additional information can be provided as specified in the instructions. For example, the data following the instructions in the routing prompt may follow the example below:
Query: “What color is my dog?”
Date/Time: “12:00:00 January 1, 2024”
Device: “Mobile Phone”
User Account: “user123”

Additionally or alternatively, in some implementations, the routing prompt may not necessarily include explicit instructions for the routing mechanism. As one example, the routing mechanism can be or can include a “heavily” fine-tuned or otherwise specialized model specifically configured for routing the query. For example, the routing mechanism can include a routing tool that is trained by a sufficient training regime such that the model expects to receive data formatted according to the routing prompt and will produce a routing output that can be utilized by the agent system without additional instructions. For instance, in the example routing prompts above, the instruction preamble may be omitted, and the data following the instructions may be presented as above without instructing the routing mechanism to interpret the data according to a particular format.

In some implementations, however, the query and the routing prompt can be the same message (e.g., having the same content). For instance, the computing system can pass the query directly to the routing mechanism as the routing prompt, without changing the content of the query. In some implementations, such as those where the query and routing prompt are the same message, generating the routing prompt based on the query can include (e.g., primarily) communication steps associated with retransmitting the query itself, such as generating the query at a new memory location inside the computing system, generating the query on an output bus of the computing system, or generating a destination for the routing prompt.

Additionally, at 708, the method 700 can include determining (e.g., by the computing system) to access a user-specific memory layer of the agent system based on an output of the routing mechanism in response to the routing prompt. For instance, the routing mechanism can produce an output that is indicative of whether to access a user-specific memory layer in response to receiving as input the routing prompt. The routing mechanism can determine, or can otherwise produce an output that the computing system can use to determine, to access a user-specific memory layer of the agent system. The user-specific memory layer can be any suitable virtual location or interface that stores, interfaces with, or otherwise provides access to user-specific information. The user-specific information can, for example, include files, images, video data, documents, historical computing system usage, or other data items that the user has placed into access via the user-specific memory layer. For instance, in some implementations, the user-specific memory layer can be, can include, or can otherwise provide access to a local storage of a calling device or user device, a cloud storage directory associated with a user, a network-accessible directory hosted on local hardware accessible by the user, a temporary storage or permanent storage of the agent system (e.g., uniquely) associated with the user, or other suitable virtual location or interface.

In some implementations, the routing mechanism or computing system can determine to access a user-specific memory layer of the agent system by determining that the agent system will evaluate at least one user-specific characteristic in performing the task. The user-specific characteristic can be uniquely associated with a user. As examples, a user-specific characteristic can have values or meanings that are different from one user to another, such as in the case of a subject referred to by a possessive pronoun such as “my spouse, my child, my parents, my vehicle, my house, my mailbox, my keys, my phone,” “we,” “us,” and so on. Information associated with the user-specific characteristic may or may not necessarily be present in the user-specific memory layer.

Determining to access the user-specific memory layer can be at least partially dependent on whether or not the task can be adequately performed with public information, training data, model resources, and so on. For instance, certain tasks, even including personal pronouns, can be performed using only public data and/or information available from communications with the agent system. As one example, a user request to “find good restaurants near my location” could be answered using publicly-available map data and a general location of the user's device, such as a location based on the user's IP address or, with consent of the user, a more granular location provided by the user to the agent system. In contrast, a request such as “what is the color of my dog” requires having access to some user-specific information relating to the subject “my dog”, such as an image of the dog or the breed of the dog. In nearly all cases, this information is not readily accessible through public data sources. Furthermore, if such information is publicly available (e.g., from a social media account of the user), that information may be privacy-protected, and it may be desirable to avoid obtaining that information from the public sources.

The routing prompt can be formatted to provide any of a variety of potential routing mechanisms. As one example, the user-specific memory layer can provide access to a number of potential data streams. In some implementations, the routing mechanism can, based on the information in the routing prompt, select a subset of the potential data streams to utilize in performing the task. As one example, if the user-specific memory layer provides access to user images and user video watch history and the routing prompt includes a query such as “retrieve an image of my dog,” the routing mechanism may utilize the information in the routing prompt to elect to access the user images and not the video watch history. As another example, the routing mechanism may rank the potential data streams and search the data streams for a reasonable answer in order of the ranking. For example, if the agent system is tasked with finding a user's license plate number, the routing mechanism may rank a web form history data stream above an image directory. The routing mechanism would then instruct the agent system to search for the user's license plate number in the web form history prior to searching the image directory. In some implementations, the data streams may be searched in parallel (e.g., by parallel threads) and the results of each search may be aggregated.

Additionally or alternatively, in some implementations, the agent system can be configured to operate on multi-modal input data. For example, the query and/or the routing prompt can be generated from some or all of multiple data input streams available to the agent system. The query can be reduced to a format that is inputtable into the agent system, which can be, for example, text data or another suitable type of data. A format or modality can be inputtable into the agent system, for instance, if the agent system includes one or more machine-learned models, portions thereof, or other input-receiving systems configured to receive input data in the format or modality and operate on the input data to produce an (e.g., meaningful) output. For instance, a sequence processing model can include a tokenizer configured to produce one or more tokens from text data, and so the text data can be inputtable into the agent system, even if the model may not necessarily operate directly on the text data. In contrast, in some cases, image data provided to a tokenizer configured specifically for text data may not produce meaningful tokens. The same agent system may or may not include or otherwise have access to another system (e.g., a neural network) that produces a meaningful output in response to the image data, however, such that the image data may nonetheless be inputtable into the agent system.

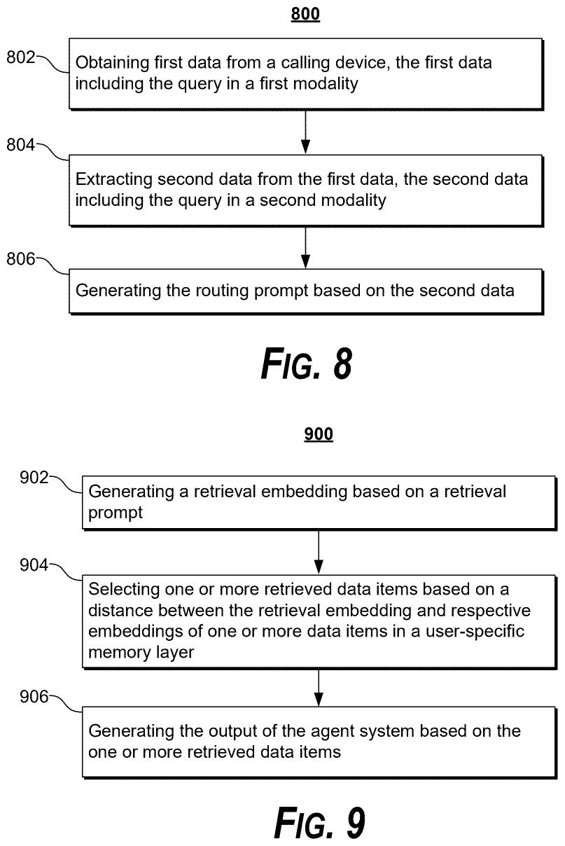

FIG. 8 depicts one example method 800 for obtaining a query and/or generating a routing prompt. Each respective portion of example method 800 can be performed by any (or any combination) of one or more computing devices. Moreover, one or more portion(s) of example method 800 can be implemented on the hardware components of the device(s) described herein, for example, to train one or more systems or models. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of example method 800 can be performed additionally, or alternatively, by other systems.

The method 800 includes, at 802, obtaining first data from a calling device. The first data can have a first modality. For instance, the first data can include the query in the first modality. As an example, the first data can include a representation of the query in the first modality. As another example, the first data can include sufficient data such that the query can be extracted from the first data. As used herein, a “modality” of data refers to a particular mode or quality in which or by which the data is expressed. As examples, modalities of data can be or can include a text or textual modality, an image or picture modality, a video modality, audio or audial modality, or a computer-readable modality (e.g., binary data). In some cases, different formats for representing a similar style of data (e.g., JPEG vs. BMP format for image data) can be considered the same or different modalities, depending on the qualities at issue.

The method 800 includes, at 804, extracting second data from the first data. The second data can have a second modality that is different from the first modality of the first data. For instance, the second data can include the query in the second modality. As one example, the second data can be or can include a representation of the query in the second modality. In some implementations, the second modality can be a modality that is inputtable to the agent system. For example, if the agent system includes one or more machine-learned models configured to operate on text data, the second modality can be text data.

In some implementations, such as implementations where the agent system is capable of receiving multiple modalities of input data, the second modality can be a modality whereby the query may be represented more reliably or relevantly. For example, an agent system may be capable of receiving both image data and text data, but text data depicting a question or request may be a more direct manner of representing the query than, for example, image data depicting the query written on a physical surface. In this example, the text data may devote less extraneous data to, for instance, the environment surrounding the written query than the image data. As another example, a sequence processing model may be more directly configured to predict tokens based on the text data when responding to a phrase than predicting tokens based on, for example, arrangement of pixels in image data depicting the written query. However, there may be other advantages to using modalities other than a most direct or most relevant modality. The second modality is expressly contemplated within the present disclosure as being any suitable modality, including image data, video data, text data, or other suitable types of data, in at least some implementations, and without being limited by the agent system except as otherwise specified herein.

The method 800 includes, at 806, generating the routing prompt based on the second data including the query in the second modality. For example, the representation of the query in the second modality can be input to the agent system and the agent system can be tasked with producing an appropriately-formatted routing prompt to provide to the routing mechanism. The query in the second modality can additionally or alternatively be used by other systems or aspects of the agent system.

As one particular example, in some implementations, the first modality can be or can include image data depicting textual characters that form the query. The second modality can be or can include text data representative of the textual characters forming the query. For example, a user can capture an image of a written representation of the query and ask the agent system to solve the query, rather than inputting the query “directly” into the agent system (e.g., by a text input field or audio input field). As a further example, obtaining the query can include obtaining an instruction to access a camera of the calling device. For example, the instruction can ask the agent or another system to “Answer the question I am pointing to.” In response to the instruction, the agent system (or another system) can obtain video data captured by the calling device. For example, the video data can be obtained from the camera of the calling device. In some implementations, the video data can be obtained from a peripheral system (e.g., camera) connected to the calling device.

As one example, the agent system can determine to employ an image data extraction tool to extract the image data from the video data captured by the calling device. For instance, in the example above, the agent system can associate the phrase “I am pointing to” with a high likelihood of relevant data being present in a visual input stream. In response to this determined high likelihood, the agent system can call the image data extraction tool. Based on an output of the image data extraction tool, the system can extract the image data from the video data captured by the calling device. For example, the image data extraction tool can obtain the video data, identify a relevant portion of the video data (e.g., based on a timestamp associated with the query at which the user is pointing to the query) and provide a relevant portion of the video data to be processed by the agent system. The system can then convert the identified portion of video data to image data. The extraction tool can identify the relevant portion of video data by, for example, timestamps, bounding boxes, color channels, and other suitable factors. The system can then generate the query descriptive of the task to be performed by the agent system based on the image data extracted from the video data captured by the calling device. As one example, if the image data depicts a written representation of text, the agent system can generate text data corresponding to the written representation.

Returning now to FIG. 7, at 710, the method 700 can include generating a retrieval prompt based on the query. The retrieval prompt can be a message or instruction that, when communicated and/or implemented by the agent system, causes the retrieval of information from the user-specific memory layer. At 712, the method 700 can include generating an output of the agent system using the user-specific memory layer and based on the retrieval prompt. For example, the agent system can retrieve user-specific information from the user-specific memory layer based on the retrieval prompt. The agent system can produce an output that incorporates or otherwise is affected by the user-specific information.

For instance, in some cases, accessing the user-specific memory layer can involve parsing through significant amounts of potentially disparate data items. For instance, the user-specific memory layer can store or provide access to a vast amount of data having several different modalities. Furthermore, this data may not be conveniently indexed for optimized retrieval. As one example, if the user-specific memory layer is or provides access to a local storage of a calling device or a cloud directory of a user, the user may have a significant amount of images, documents, or other data items that could provide helpful information in performing the user-specific task. However, the agent system does not immediately know which items will prove useful, and manually parsing each item can result in significant wasted computing resources.

In some implementations, the user-specific information retrieved by the agent system from the user-specific memory layer can be or can include one or more retrieved data items. For example, The retrieval prompt can be a message or instruction that, when communicated and/or implemented by the agent system, causes the retrieval of the one or more retrieved data items from the user-specific memory layer. The output of the agent system can be generated based on the one or more retrieved data items. For instance, the retrieved data items can describe user-specific information that is relevant for performing the task for the user.

In some implementations, data items in the user-specific memory layer can be indexed to facilitate improved retrieval by the agent system. In some implementations, the data items can be indexed prior to accessing the user-specific memory layer for performing the task. For example, in some implementations, the data items are indexed as they are added to the user-specific memory layer. In particular, in some implementations, generating the output of the agent system includes retrieving one or more retrieved data items from the user-specific memory layer based on a comparison between indices of one or more data items contained in the user-specific memory layer and the retrieval prompt.

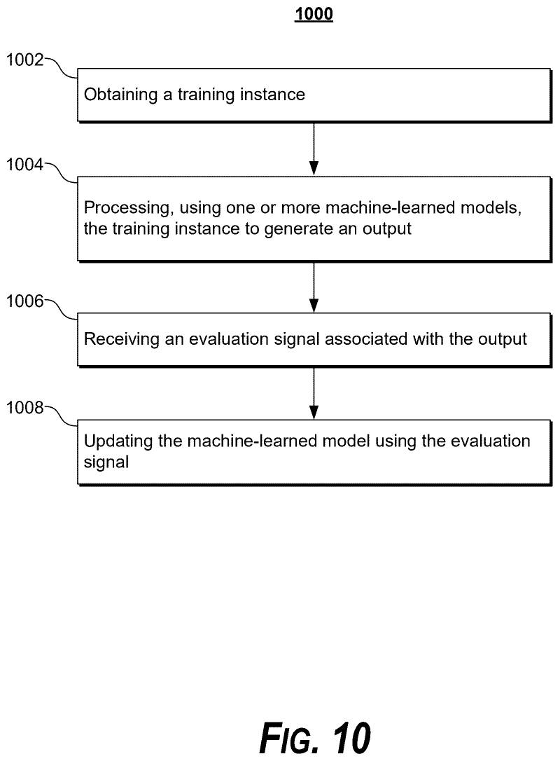

In some implementations, retrieving the one or more retrieved data items can be performed based on an embedding-based indexing approach. FIG. 9 depicts an example method 900 for generating output of an agent system according to example implementations of aspects of the present disclosure. Each respective portion of example method 900 can be performed by any (or any combination) of one or more computing devices. Moreover, one or more portion(s) of example method 900 can be implemented on the hardware components of the device(s) described herein, for example, to train one or more systems or models. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of example method 900 can be performed additionally, or alternatively, by other systems.

At 902, the method can include generating a retrieval embedding based on a retrieval prompt. The retrieval prompt can be the retrieval prompt discussed with reference to FIG. 7 (e.g., at 710). In some implementations, generating the retrieval embedding includes projecting the retrieval prompt into a multidimensional embedding space. In addition, the indices of the one or more data items contained in the user-specific memory layer can be or can include respective embeddings of the one or more data items. Data items can map to a set of discrete locations in the embedding space. As an example, an arbitrary data item, such as the retrieval prompts and/or the data items of the user-specific memory layer can be mapped or projected into the embedding space through a projection algorithm that reduces the data item to values of one or more coordinates of dimensions in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space. Relationships between elements can be represented or even inferred based on distances between the respective embeddings of the elements in the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

At 904, the method 900 can include selecting one or more retrieved data items based on a distance between the retrieval embedding and the respective embeddings of one or more data items in a user-specific memory layer. The indices of the one or more data items contained in the user-specific memory layer can be or can include the respective embeddings of the one or more data items. The distance between the retrieval embedding and a respective embedding can be determined by an n-dimensional Euclidean distance, where n is the number of dimensions in the embedding space, or any other suitable distance measurement technique. As an example, a data item where the distance between the retrieval embedding and the respective embedding of the data items satisfies (e.g., is less than or is less than or equal to) a distance threshold, can be selected as the retrieved data items. Additionally or alternatively, a data item where the distance between the retrieval embedding and the respective embedding of the data item does not satisfy (e.g., is greater than or is greater than or equal to) the distance threshold can not be selected as a retrieved data item.

At 906, the method 900 can include generating the output of the agent system based on the one or more retrieved data items. As described above (e.g., with respect to step 712 of method 700), the agent system can produce an output that is responsive to the task based on the information in the user-specific memory layer. As one example, if the task is to provide the user with an output responsive to a question involving user-specific information, such as “what is my vehicle identification number,” the retrieved data items may include relevant, but not ultimately dispositive, data items such as, for example, an image of the user's vehicle depicting the vehicle identification number on a label or sticker of the vehicle. The agent system can, in some implementations, provide the retrieved data items directly in the output.

To generate the output, the agent system can extract information from the retrieved data items and/or combine the information from the retrieved data items into a coherent output. As one example, the agent system can perform optical character recognition on textual information depicted in image data of the retrieved data items. For example, in the vehicle identification number example above, the agent system can extract the vehicle identification number from the image of the vehicle. The agent system can produce a coherent output including, but not necessarily limited to, the extracted information. For example, the agent system can produce a conversationally-styled output. In the VIN example above, for instance, the agent system may produce a phrase such as “Of course, I found a picture of your vehicle and it looks like your VIN is” followed by the user's VIN extracted from the image and/or the image itself. As another example, the agent system can crop image or video data of an image depicting multiple subjects if the task is related to only some of the multiple subjects in the image or video data. For example, if a user asks the agent system to retrieve an image of a spouse, the agent system can crop people other than the user's spouse out of a group picture including the user's spouse. As yet another example, if the user asks the agent system to retrieve a portion of a recently watched video relating to a given topic, the agent system can generate an output including only the portion of the video relating to the given topic.

In some implementations, the agent system can further narrow the set of relevant data items by parsing the retrieved data items based on its knowledge of the query and the task. For instance, in some implementations, generating the output of the agent system based on the one or more retrieved data items includes prompting the agent system to select one or more output items from the one or more retrieved data items. The output of the agent system can include, be based on, or otherwise be dependent on the one or more output items. Additionally or alternatively, the output of the agent system can exclude the retrieved data items that are not present in the output items. For example, in some implementations, the retrieved data items can be provided to the agent system along with a prompt instructing the agent system to, for example, select the most relevant data items for performing the task.

Returning again to FIG. 7, in some implementations, the method 700 can optionally include, at 714, providing (e.g., by the computing system) the output of the agent system to a user. The output can be provided or communicated by any suitable manner over, for example, a local or wired data connection, connection over one or more networks, or other suitable manner of transmission. For instance, the agent system can provide the output to the user who requested the agent system to perform the task via the query. Additionally or alternatively, in some implementations, the agent system can provide the output to a user other than the user who provided the query. For example, a first user can request that the agent system draft an email including a picture of the user's cat and send the email to a second user. The email (e.g., the output of the agent system) can then be sent to the second user, although the first user requested that the email be drafted.

In some implementations, the agent system can additionally be configured to perform user-agnostic tasks. The user-agnostic tasks can be performed without accessing the user-specific memory layer. For instance, the user-agnostic tasks can be performed using only the internal capabilities of the model(s) of the agent system (e.g., without accessing any additional data). As another example, the user-agnostic tasks can be performed by the internal capabilities of the model and/or by accessing a public data interface providing access to public data sources. For example, the agent system can generate an answer using machine-learned model(s) (e.g., sequence processing model(s)) and may seek to include references to one or more verifiable external sources to improve the user's confidence in the output of the agent system. According to example aspects of the present disclosure, the routing mechanism described herein can be employed to determine whether to access public data interfaces and/or perform the task without accessing public data interfaces or the user-specific memory layer, in addition to determining whether to perform a user-specific task by accessing the user-specific memory layer. The agent system can therefore be invoked by the user to perform a wide variety of tasks which may be seamlessly performed by the agent system. This can provide for improved trust in the user of the agent system, improved user experience for users of the agent system, improved user retention of the agent system, and reduced computing resources associated with users navigating to other agent systems for performing different types of tasks.

As one example, a computing system can obtain a second query descriptive of a second task to be performed by the agent system and generate a second routing prompt based on the second query. The second query, second task, and second routing prompt may be similar to or identical to the (e.g., first) query, task, and routing prompt discussed above except where otherwise indicated. The second task can be a user-agnostic task, which may not be immediately known by the agent system.

The computing system can provide the second routing prompt to the routing mechanism of the agent system to determine whether the second task is a user-specific or user-agnostic task (e.g., whether to access the user-specific memory layer or public data interface(s)). The routing mechanism can provide an output in response to the second routing prompt. For example, the routing mechanism can provide an output that is indicative of whether external data sources will (a) be required to adequately perform the second task; (b) be helpful in informing the performance of the second task; (c) improve the user's confidence in the output of the agent system; or otherwise be beneficial to access. The computing system can determine to access a public data interface to perform the second task using the agent system based on the output of the routing mechanism of the agent system in response to the second routing prompt.

The computing system can further generate a second retrieval prompt based on the second query and generate a second output of the agent system by accessing the public data interface based on the second retrieval prompt. The retrieval prompt and the second retrieval prompt can include different instruction formats. For instance, the second retrieval prompt can be formatted in accordance with formatting requirements of the public data interface, if applicable. As an example, some public data interfaces can be configured to receive prompts in conformance with a specific format or protocol, such as the Hypertext Transfer Protocol (HTTP), the JavaScript Object Notation (JSON) format, the Transmission Control Protocol/Internet Protocol (TCP/IP), or other suitable format or protocol. The computing system can provide the second retrieval prompt to the public data interface and receive data items, such as public data items, from the public data interface. The data items received from the public data interface can be used in generating the second output, such as by reinforcing factual assertions in an output from the agent system. The computing system can additionally, in some implementations, provide the second output to a calling device or user device that provided the second query and/or another suitable computing device.

Additionally or alternatively, in some implementations, a computing system can obtain a third query descriptive of a third task to be performed by the agent system and generate a third routing prompt based on the third query. The third query, third task, and third routing prompt may be similar to or identical to the (e.g., first) query, task, and routing prompt discussed above except where otherwise indicated. The third task can be a user-agnostic task, which may not be immediately known by the agent system. Additionally, the third task can be a task that is within the capability of the agent system to perform without accessing external data sources.

The computing system can provide the third routing prompt to the routing mechanism of the agent system. The routing mechanism can produce an output in response to the third routing prompt. The output can indicate to provide the query (e.g., directly) to the agent system. For example, the routing mechanism can determine that the task can be performed without accessing a user-specific memory layer or any public data interfaces. The computing system can determine to provide the query to the agent system based on the output of the routing mechanism of the agent system in response to the third routing prompt. The computing system can generate a third output of the agent system based on the third query. The computing system can additionally, in some implementations, provide the third output to a calling device or user device that provided the third query and/or another suitable computing device.

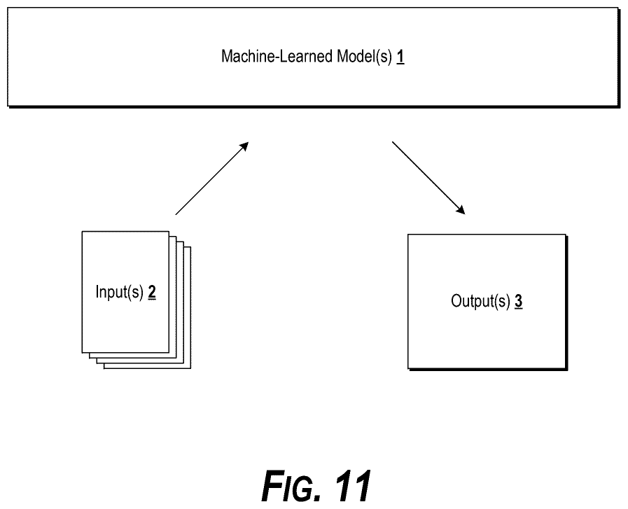

FIG. 10 depicts a flowchart of a method 1000 for training one or more machine-learned models according to aspects of the present disclosure. For instance, an example machine-learned model can include a sequence processing model.

One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

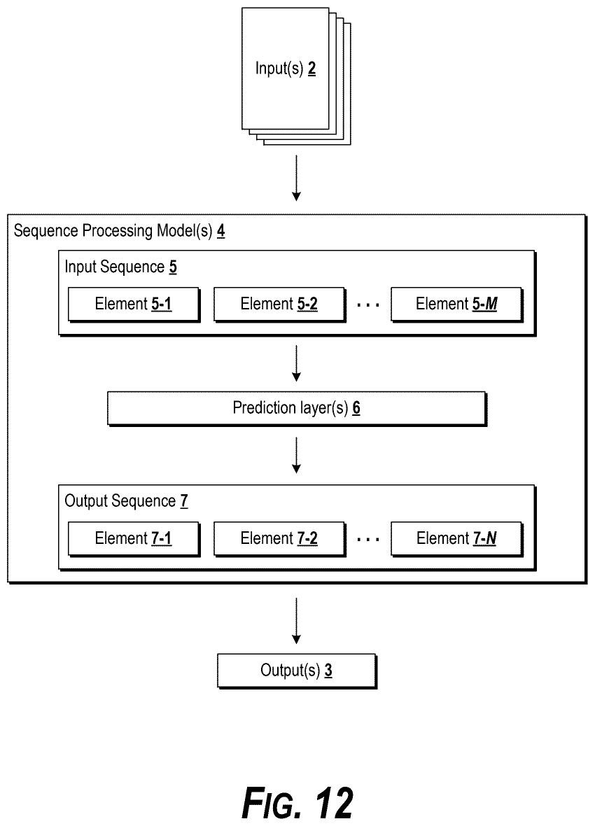

FIG. 11 is a block diagram of an example processing flow for using machine-learned model(s) 1 to process input(s) 2 to generate output(s) 3.

Machine-learned model(s) 1 can be or include one or multiple machine-learned models or model components. The machine-learned model(s) 1 can be or can include, for example, the machine-learned model(s) 214 of FIG. 2 and/or one or more machine-learned models employed by agent system(s) 102, 201, 304, and/or 402 of FIGS. 1-4. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models. For example, the machine-learned models can be or include transformer models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

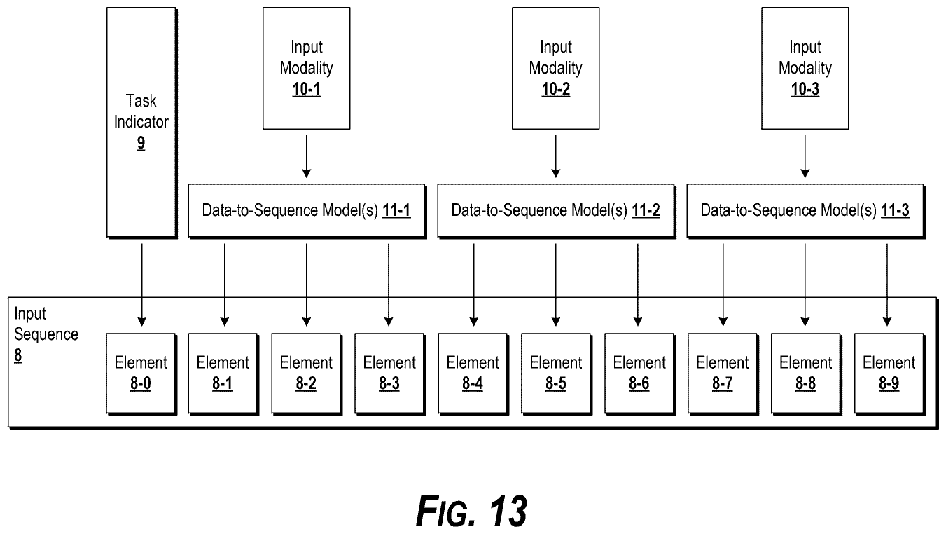

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-Nov. 4, 2018), https://aclanthology.org/D18-2012.pdf. Image-based input source(s) can be tokenized by extracting and serializing patches from an image. Other tokenization approaches can be performed as well, including linear projections, non-linear transformations, and/or other data transformations.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via an input sequence 5.

Output sequence 7 can be generated autoregressively. For instance, for some applications, an output of one or more prediction layer(s) 6 can be passed through one or more output layers (e.g., SoftMax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

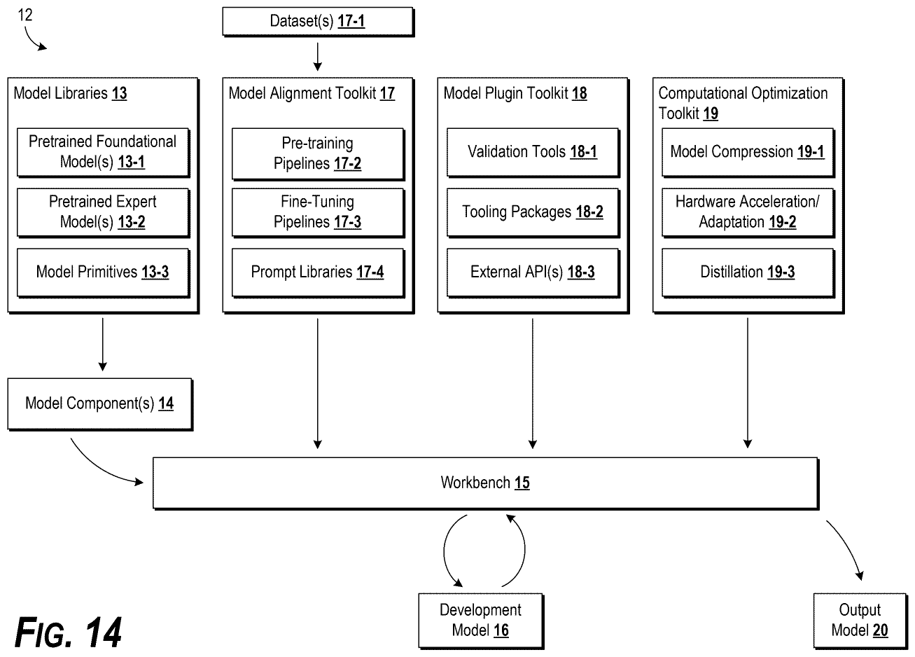

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

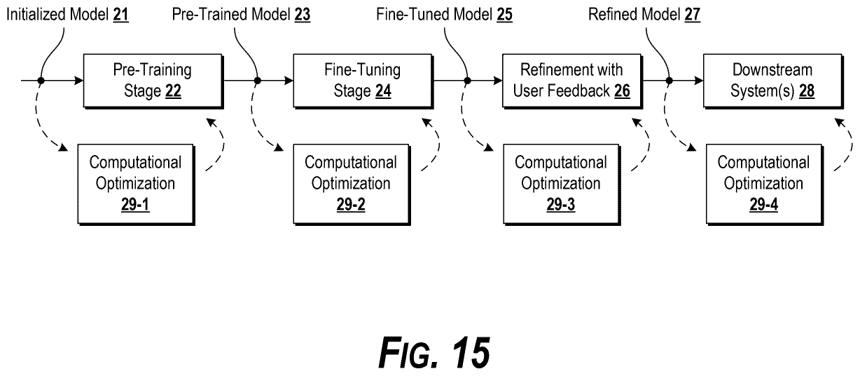

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. As another example, a tool can have a machine-learned model with reduced model overhead compared to a larger machine-learned model. For instance, the model of the tool can be a less sophisticated model than the calling model that is specialized to a particular task or subset of tasks and can require fewer computing resources to produce a usable output. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem or for evaluation of simpler tasks that can be adequately performed by a less sophisticated model.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”). One example tool that can be included in validation tools 18-1 is a routing tool for routing a query from a user to a user-specific memory layer or a public data interface.

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems. As an example, the development model 16 can initiate API calls to one or more public data interface(s) to send or obtain data from one or more public data sources, such as webpages, databases, and so on.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

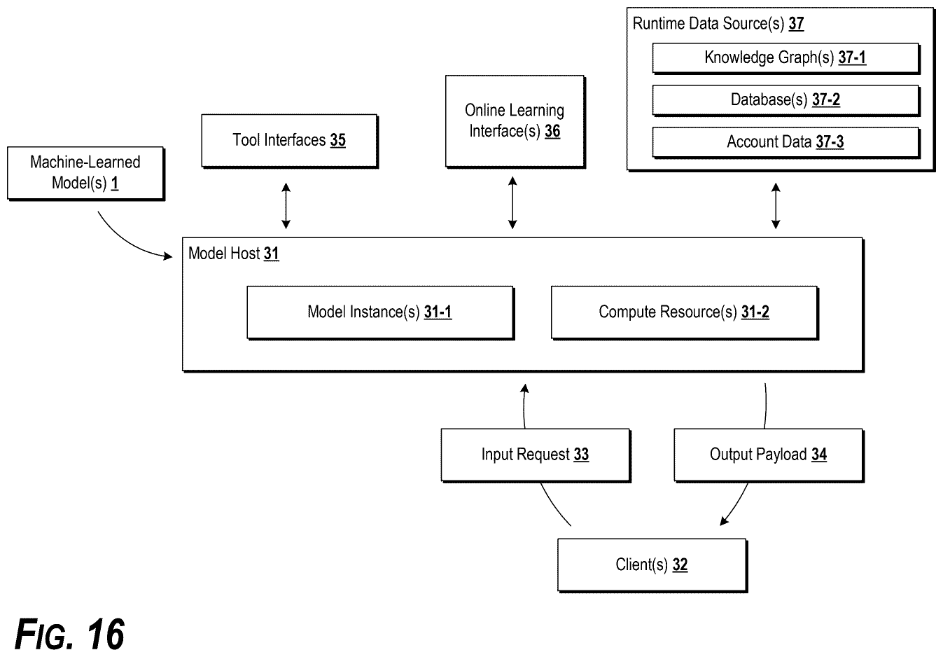

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1,. 29-4 can all be the same, all be different, or include at least some different optimization techniques.

### Example Machine-Learned Model Inference System

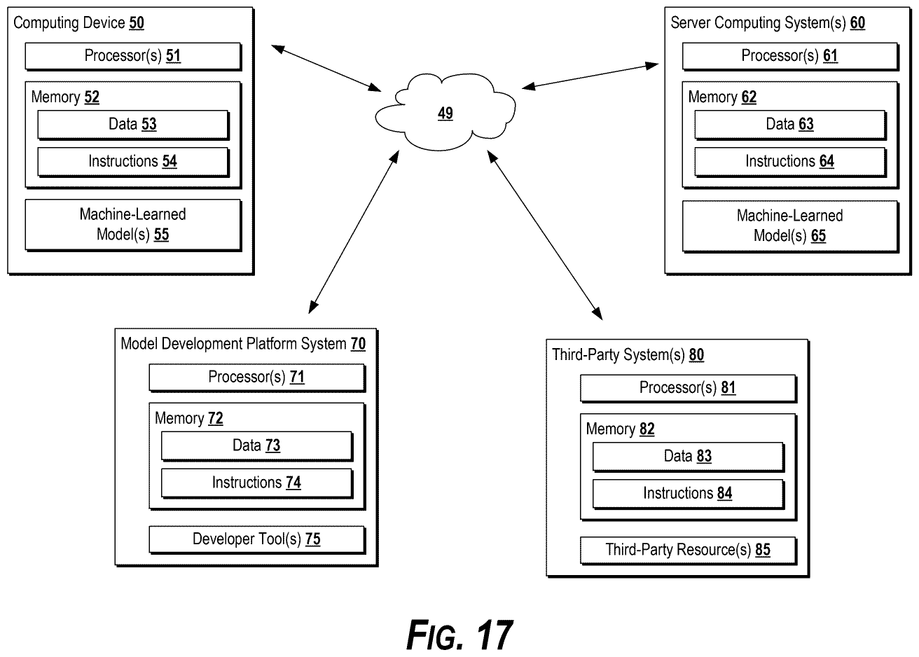

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on or in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model can generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task can be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task can be an audio compression task. The input can include audio data and the output can be or can include compressed audio data. In another example, the input includes visual data (e.g. one or more images or videos), the output includes compressed visual data, and the task is a visual data compression task. In another example, the task can include generating an embedding for input data (e.g. input audio or visual data). In some cases, the input includes audio data representing a spoken utterance and the task is a speech recognition task. The output can be or can include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

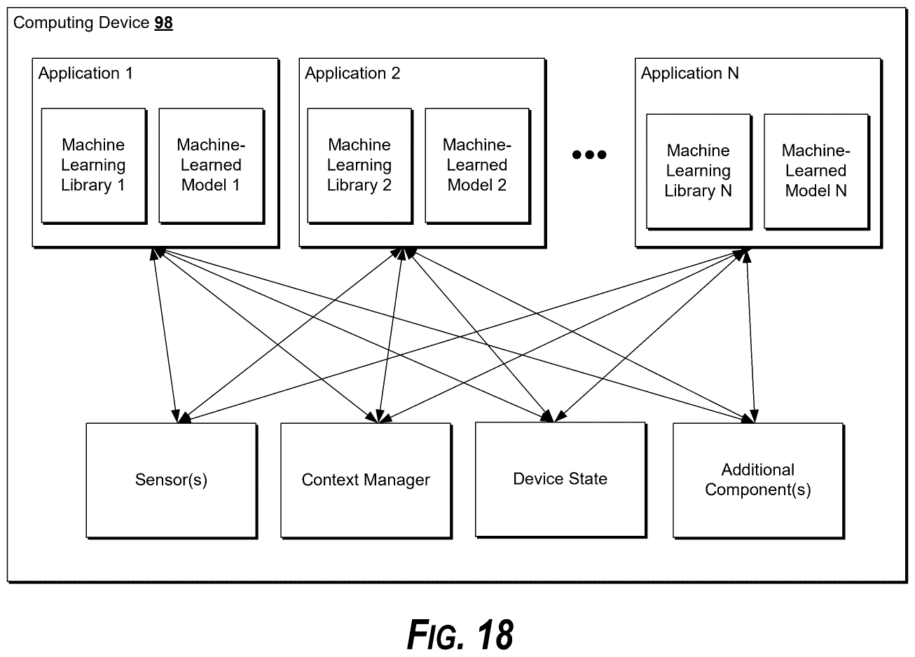

FIG. 17 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 17 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who can use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 17 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

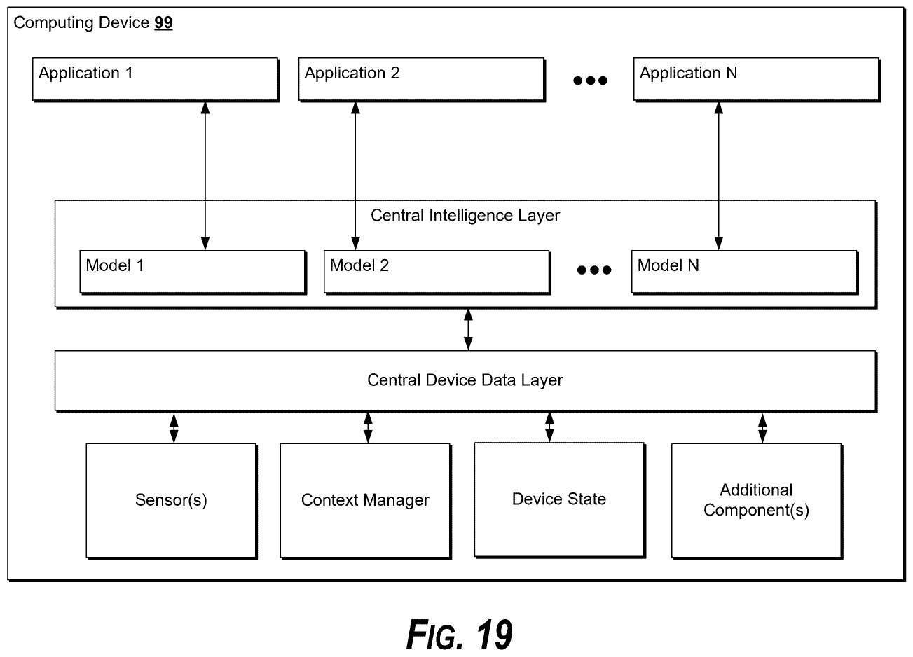

FIG. 18 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 18, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 19 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 19, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 19, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
obtaining, by a computing system comprising one or more computing devices, a query descriptive of a task to be performed by an agent system;
generating, by the computing system, a routing prompt based on the query;
providing, by the computing system, the routing prompt as input to a routing mechanism of the agent system;
determining, by the computing system, to access a user-specific memory layer of the agent system based on an output of the routing mechanism in response to the routing prompt;
generating, by the computing system, a retrieval prompt based on the query; and
generating, by the computing system, an output of the agent system using the user-specific memory layer and based on the retrieval prompt.

2. The computer-implemented method of claim 1, wherein obtaining the query comprises:
obtaining first data from a calling device, the first data comprising the query in a first modality;
extracting second data from the first data, the second data comprising the query in a second modality; and
generating the routing prompt based on the second data comprising the query in the second modality.

3. The computer-implemented method of claim 2, wherein the first modality comprises image data depicting textual characters comprising the query and the second modality comprises text data representative of the textual characters comprising the query.

4. The computer-implemented method of claim 3, wherein obtaining the query further comprises:
obtaining an instruction to access a camera of the calling device;
in response to the instruction, obtaining video data captured by the calling device;
determining to employ an image data extraction tool to extract the image data from the video data captured by the calling device;
based on an output of the image data extraction tool, extracting the image data from the video data captured by the calling device; and
generating the query descriptive of the task to be performed by the agent system based on the image data extracted from the video data captured by the calling device.

5. The computer-implemented method of claim 1, wherein the routing prompt comprises metadata associated with the query.

6. The computer-implemented method of claim 1, wherein generating the output of the agent system comprises:
retrieving one or more retrieved data items from the user-specific memory layer based on a comparison between indices of one or more data items contained in the user-specific memory layer and the retrieval prompt; and
generating the output of the agent system based on the one or more retrieved data items.

7. The computer-implemented method of claim 6, wherein generating the output of the agent system based on the one or more retrieved data items comprises prompting the agent system to select one or more output items from the one or more retrieved data items, the output of the agent system comprising the one or more output items.

8. The computer-implemented method of claim 6, wherein:
the indices of the one or more data items contained in the user-specific memory layer comprise respective embeddings of the one or more data items; and
retrieving the one or more retrieved data items from the user-specific memory layer based on a comparison between the indices of the one or more data items and the retrieval prompt comprises:
generating a retrieval embedding based on the retrieval prompt; and
selecting the one or more retrieved data items based on a distance between the retrieval embedding and the respective embeddings of the one or more data items.

9. The computer-implemented method of claim 1, wherein determining to access a user-specific memory layer of the agent system comprises determining that the agent system will evaluate at least one user-specific characteristic in performing the task, the user-specific characteristic uniquely associated with a user.

10. The computer-implemented method of claim 1, wherein the user-specific memory layer comprises one of a local storage of a calling device or a cloud storage directory associated with a user.

11. The computer-implemented method of claim 1, wherein the routing mechanism comprises a routing tool of the agent system, and wherein the routing tool is generated by the agent system to classify a query as one of a user-specific query or a user-agnostic query.

12. The computer-implemented method of claim 1, further comprising:
obtaining, by the computing system, a second query descriptive of a second task to be performed by the agent system;
generating, by the computing system, a second routing prompt based on the second query;
providing, by the computing system, the second routing prompt to the routing mechanism of the agent system;
determining, by the computing system, to access a public data interface to perform the second task using the agent system based on an output of the routing mechanism of the agent system in response to the second routing prompt;
generating, by the computing system, a second retrieval prompt based on the second query; and
generating, by the computing system, a second output of the agent system by accessing the public data interface based on the second retrieval prompt.

13. The computer-implemented method of claim 12, wherein the retrieval prompt and the second retrieval prompt comprise different instruction formats.

14. The computer-implemented method of claim 1, further comprising:
obtaining, by the computing system, a third query descriptive of a third task to be performed by the agent system;
generating, by the computing system, a third routing prompt based on the third query;
providing, by the computing system, the third routing prompt to the routing mechanism of the agent system;
determining, by the computing system, to provide the query to the agent system based on an output of the routing mechanism of the agent system in response to the third routing prompt; and
generating, by the computing system, a third output of the agent system based on the third query.

15. A computing system, comprising:
one or more processors; and
one or more non-transitory, computer-readable media storing instructions that, when implemented, cause the one or more processors to perform operations, the operations comprising:
obtaining a query descriptive of a task to be performed by an agent system;
generating a routing prompt based on the query;
providing the routing prompt as input to a routing mechanism of the agent system;
determining to access a user-specific memory layer of the agent system based on an output of the routing mechanism of the agent system in response to the routing prompt;
generating a retrieval prompt based on the query; and
generating an output of the agent system using the user-specific memory layer and based on the retrieval prompt.

16. The computing system of claim 15, wherein obtaining the query comprises:
obtaining first data from a calling device, the first data comprising the query in a first modality;
extracting second data from the first data, the second data comprising the query in a second modality; and
generating the routing prompt based on the second data comprising the query in the second modality.

17. The computing system of claim 15, wherein the routing prompt comprises metadata associated with the query.

18. The computing system of claim 15, wherein generating the output of the agent system comprises:
retrieving one or more retrieved data items from the user-specific memory layer based on a comparison between indices of one or more data items contained in the user-specific memory layer and the retrieval prompt; and
generating the output of the agent system based on the one or more retrieved data items.

19. The computing system of claim 18, wherein:
the indices of the one or more data items contained in the user-specific memory layer are based on respective embeddings of the one or more data items; and
retrieving the one or more retrieved data items from the user-specific memory layer based on a comparison between the indices of the one or more data items and the retrieval prompt comprises:
generating a retrieval embedding based on the retrieval prompt; and
selecting the one or more retrieved data items based on a distance between the retrieval embedding and the respective embeddings of the one or more data items.

20. One or more non-transitory, computer-readable media storing instructions that, when implemented, cause one or more processors to perform operations, the operations comprising:
obtaining a query descriptive of a task to be performed by an agent system;
generating a routing prompt based on the query;
providing the routing prompt as input to a routing mechanism of the agent system;
determining to access a user-specific memory layer of the agent system based on an output of the routing mechanism of the agent system in response to the routing prompt;
generating a retrieval prompt based on the query; and
generating an output of the agent system using the user-specific memory layer and based on the retrieval prompt.
